(19) United States
(12) Patent Application Publication
(10) Pub. No.: US 2024/0053163 A1
(43) Pub. Date: Feb. 15, 2024

(54) GRAPHICAL USER INTERFACE AND USER EXPERIENCE ELEMENTS FOR HEAD UP DISPLAY DEVICES

(71) Applicant: WAYRAY AG, Zürich (CH)

(72) Inventors: Maksim SHTOK, Zurich (CH); Ivan PANCHENKO, Moscow (RU)

(21) Appl. No.: 18/257,951

(22) PCT Filed: Jan. 22, 2021
(86) PCT No.: PCT/IB2021/050499

§ 371 Date: Jun. 16, 2023

(30) Foreign Application Priority Data
Dec. 17, 2020 (WO) WIPO100027

(51) Int. Cl. G01C 21/36

(52) U.S. Cl. CPC G01C 21/365; G01C 21/3632

(57) ABSTRACT

Disclosed embodiments are related to user experience and user interface (UX/UI) elements for projector-based systems, such as head-up displays, head-mounted displays, virtual/augmented reality systems, and the like. The UX/UI elements may include pointers that convey turn-by-turn (TBT) indications while travelling along a planned route, where different pointers are displayed based on maneuvers to be performed at maneuver points. The pointers include directional pointers to be displayed when a maneuver involves a left or right turn, and gyroscopic pointers to be displayed for negotiating complicated maneuvers such as navigating around a roundabout. Other embodiments may be disclosed and/or claimed.

### CROSS-REFERENCE TO RELATED APPLICATIONS

The present application claims priority to Int'l Design App. No. WIPO100027 filed Dec. 17, 2020, the contents of which are hereby incorporated by reference in its entirety.

### TECHNICAL FIELD

Embodiments discussed herein are generally related to graphical user interfaces (GUIs), Head-Up Display (HUD) devices, and navigational instruments, and in particular, to GUIs providing visual route guidance for use in HUD devices.

### BACKGROUND

Navigation services have been widely deployed in as standalone services or integrated with telecommunication services. One such navigation service is turn-by-turn (TBT) navigation, which is a feature of some standalone navigation devices (e.g., global navigation satellite system (GNSS) units) or mobile devices that include a navigation device. TBT navigation involves continually presenting directions for a selected route to a user as the user travels along the route. The directions are provided to the user as the user (or user's vehicle) arrives at, or approaches, a landmark or geolocation where the user should turn in order to continue travelling along the desired route. The directions are often provided in the form of spoken or visual instructions. The visual instructions may be in the form of GUI elements displayed on a display device.

Traditionally, navigational GUIs have been cumbersome in terms of user interaction and are often difficult to view on a small navigational screen where the display size is constrained (e.g., in a smartphone, tablet, portable GPS/navigation units, etc.). These issues are exacerbated when attempting to provide TBT navigation GUI elements on display screens of Head-Up Display (HUD) devices.

Another issue with traditional navigational GUIs is that they can sometimes point in an incorrect or confusing manner (from the user's perspective). This issue often can arise when the navigation application is not optimized for a particular display screen. Additionally, this issue may arise when the user (or vehicle) needs to maneuver around uncommon objects or landmarks, or when the user (or vehicle) needs to maneuver through an unconventional roadway layouts, such as when a road system is not laid out in a grid.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings:

FIG. 1 illustrates various perspective views of a gyroscopic navigation pointer as viewed through a vehicle head up display (HUD) according to various embodiments.

FIG. 2 illustrates rotational motions of the gyroscopic navigation pointer of FIG. 1 according to various embodiments.

FIG. 3 illustrates an example operational scenario for a gyroscopic navigation pointer according to various embodiments.

FIGS. 4-11 illustrate example user interfaces (UIs) of a vehicle HUD as the vehicle performs maneuvers at or around a roundabout according to various embodiments.

FIG. 12 illustrates various views of a turn-by-turn (TBT) navigation pointer as viewed through a vehicle HUD according to various embodiments.

FIG. 13 illustrates an example operational scenario for a TBT navigation pointer according to various embodiments.

FIGS. 14-21 illustrate UIs of a vehicle HUD as the vehicle performs a right turn maneuver according to various embodiments.

FIGS. 22-23 illustrate different pointers GUI elements that may be used as the gyroscopic pointer and/or directional/TBT pointers discussed herein.

FIG. 24 schematically illustrates a Head-Up Display (HUD) system using a projector with laser light source, according to various embodiments.

FIG. 25 illustrates an example HUD system for a vehicle according to various embodiments.

FIG. 26 illustrates an example display system configurable to interface with an on-board vehicle operating system according to various embodiments.

FIG. 27 illustrates an example implementation of a vehicle embedded computer device according to various embodiments.

FIG. 28 illustrates a process for practicing the embodiments discussed herein.

### DETAILED DESCRIPTION

Embodiments discussed herein generally relate to user experience and user interface (UX/UI) elements for head-up display (HUD) devices, and in particular to navigational UX/UI elements that guide vehicle operators through maneuvers. In various embodiments, a HUD device is disposed in a vehicle and displays navigational UX/UI elements to convey maneuvers for travelling along a desired route. Examples of maneuvers to be performed can include hard turns (e.g., 90° or more), slight or soft turns (e.g., less than 90 W), U-turns, merging onto a road (e.g., highway), exiting a roadway (e.g., a highway), changing lanes, vearing in a particular direction, braking, accelerating, decelerating, and/or the like, roundabout negotiation, and/or the like. The HUD device displays different navigational UX/UI elements based on the type of maneuver to be performed and based on the position of the HUD device (or vehicle) with respect to the location at which the meaneuver is to be performed (referred to as a “maneuver point” or the like). The type of maneuver to be performed may be based on the travel path and/or objects that need to be negotiated. For example, the HUD device may display directional navigational elements (also referred to as “turn-by-turn pointers,” “turn arrows”, and the like) when the vehicle needs to navigate through (or around) a roundabout, and the HUD device may display a gyroscopic navigational element (also referred to as “compass pointers”) when the vehicle needs to navigate through (or around) complicated road junctions, such as roundabouts and the like.

In various embodiments, the navigational UX/UI elements are augmented reality (AR) arrow-like objects that point where the driver needs to go during operation of the vehicle. In some embodiments, a navigational UX/UI element has two rotation origins points including a first origin point for yaw and roll motions and a second origin point for pitch motions. The first origin may be located higher than the UX/UI element and/or higher than the second origin point. The second origin point may be disposed in the center of the UX/UI element. The multiple rotation origins create specific rotation mechanics for the UX/UI element that appears more natural and provide navigational information in a more intuitive manner than existing TB navigational systems. Additionally, the UX/UI elements discussed herein provide stability and high readability in comparison to existing TBT navigation systems. Other embodiments may be described and/or claimed.

The following detailed description refers to the accompanying drawings in which are shown, by way of illustration, embodiments that may be practiced. The same reference numbers may be used in different drawings to identify the same or similar elements. Various operations may be described as multiple discrete operations in turn, in a manner that may be helpful in understanding embodiments; however, the order of description should not be construed to imply that these operations are order-dependent. The description may use perspective-based descriptions such as up/down, back/front, top/bottom, and the like. Such descriptions are merely used to facilitate the discussion and are not intended to restrict the application of disclosed embodiments.

In the following description, for purposes of explanation and not limitation, specific details are set forth such as particular structures, architectures, techniques, etc. in order to provide a thorough understanding of various aspects of the embodiments. However, in certain instances, descriptions of well-known elements, devices, components, circuits, methods, etc., are omitted so as not to obscure the description of the embodiments with unnecessary detail. It will be apparent to those skilled in the art having the benefit of the present disclosure that aspects of the embodiments may be practiced in ways that depart from the specific details discussed herein. It is to be understood that other embodiments may be utilized and structural or logical changes may be made without departing from the scope of the present disclosure. Therefore, the following detailed description is not to be taken in a limiting sense.

For illustrative purposes, the following description is provided for deployment scenarios including vehicles in a two dimensional (2D) roadway environment wherein the vehicles are automobiles. However, the embodiments described herein are also applicable to other types of terrestrial vehicles, such as trucks, busses, motorcycles, trains, and/or any other motorized devices capable of transporting people or goods that include or implement head-up display (HUD) devices or systems. The embodiments described herein may also be applicable to deployment scenarios involving watercraft implementing HUD systems such as manned and/or unmanned boats, ships, hovercraft, and submarines. The embodiments described herein may also be applicable to three dimensional (3D) deployment scenarios where some or all of the vehicles are flying objects implementing HUD systems, such as aircraft, drones, unmanned aerial vehicles (UAVs), and/or the like, Furthermore, the embodiments herein may also be applicable to deployment scenarios involving micro-mobility vehicles (MMVs) when the user/operator of such an MMV implements a head-mounted display (HMD) device (e.g., motorcycle or pilots helmet HUD, smart glasses, etc.), an AR or virtual reality (VR) system or headset, and/or a handheld mobile device (e.g., smartphone, tablet, GPS unit, etc.). MMVs may include electric/combustion MMVs and human powered MMVs. Examples of human powered MMVs include bicycles, skateboards, scooters, and the like. Examples of electric/combustion MMVs include electric bikes, powered standing scooters (e.g., Segway®); powered seated scooters, self-balancing boards or self-balancing scooters (e.g., Hoverboard® self-balancing board, and Onewheel® self-balancing single wheel electric board), powered skates, and/or the like.

### 1. Gyroscopic Navigation Pointers

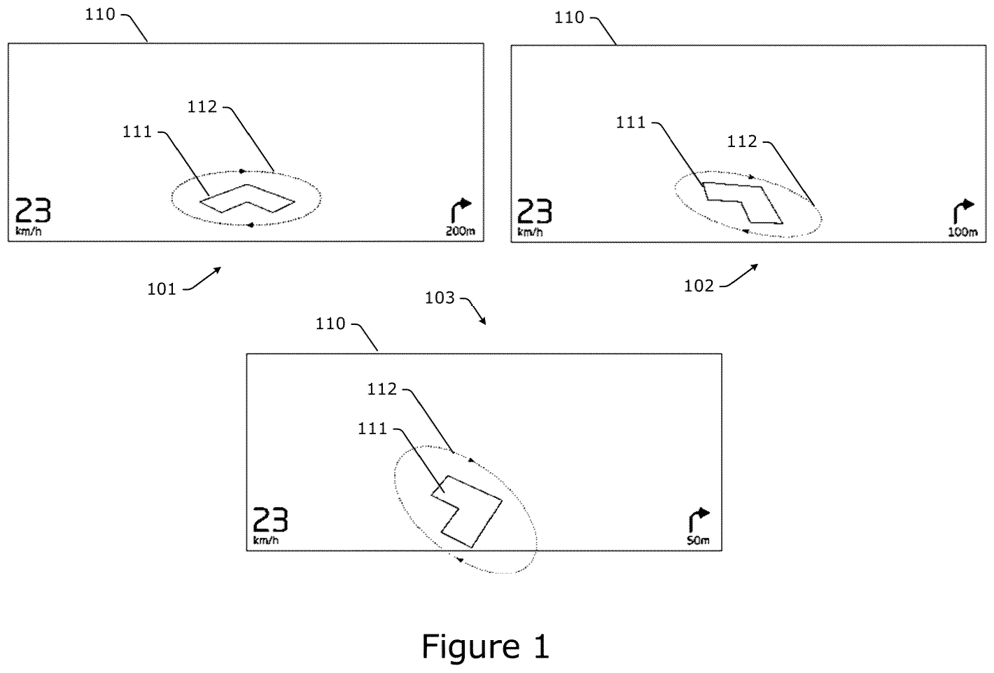

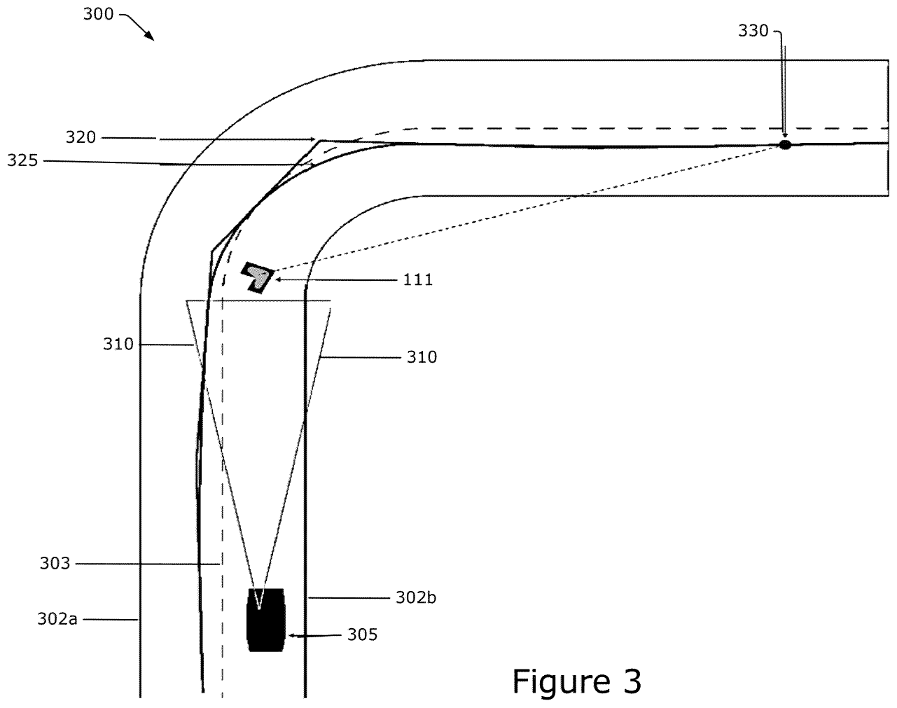

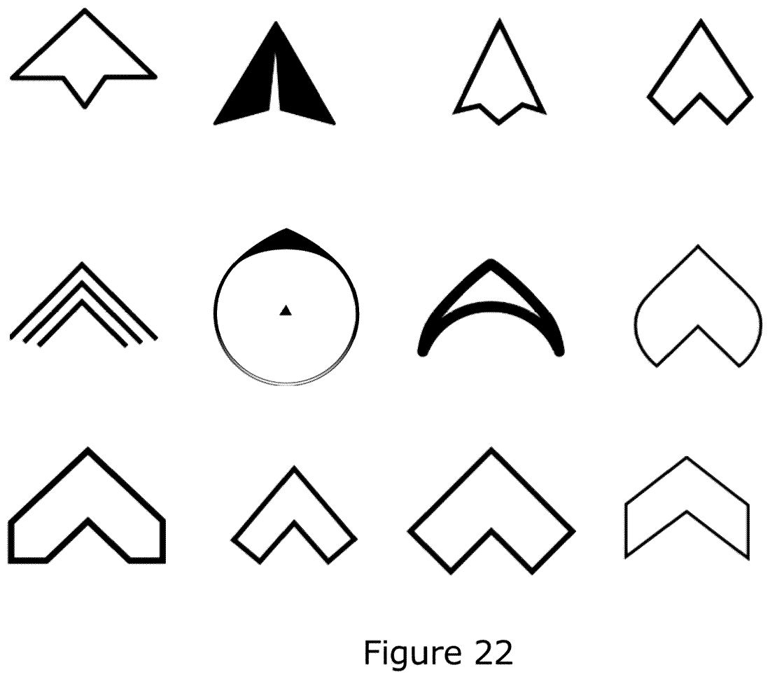

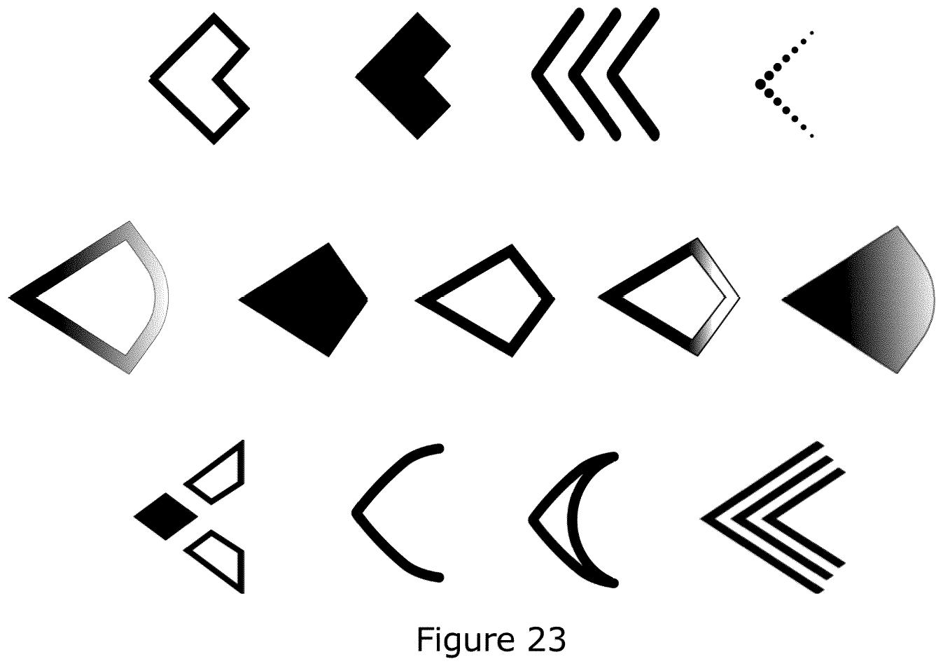

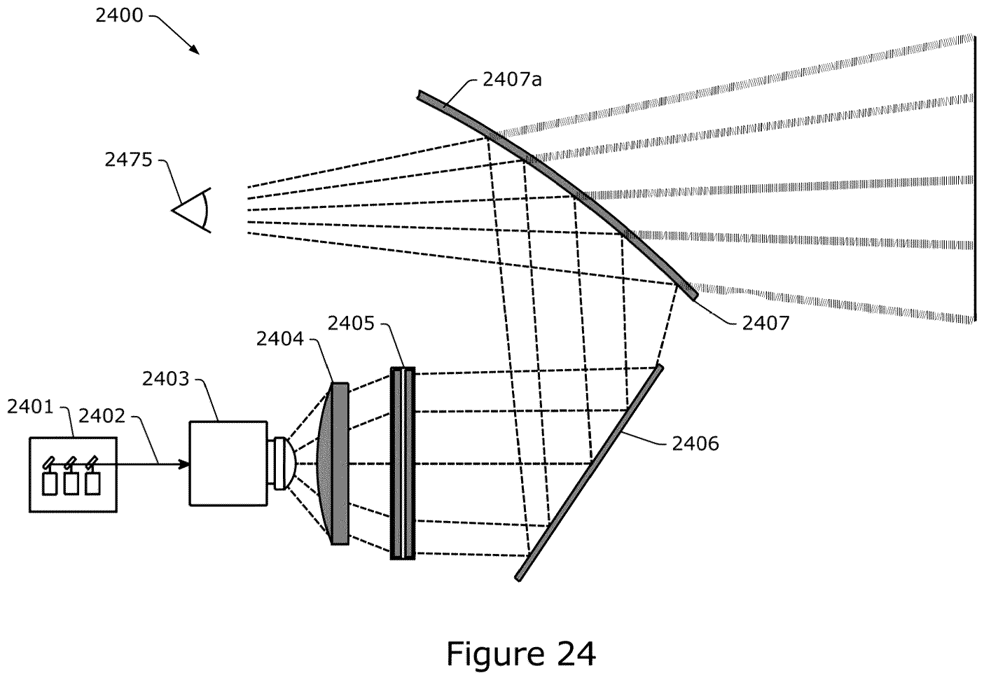

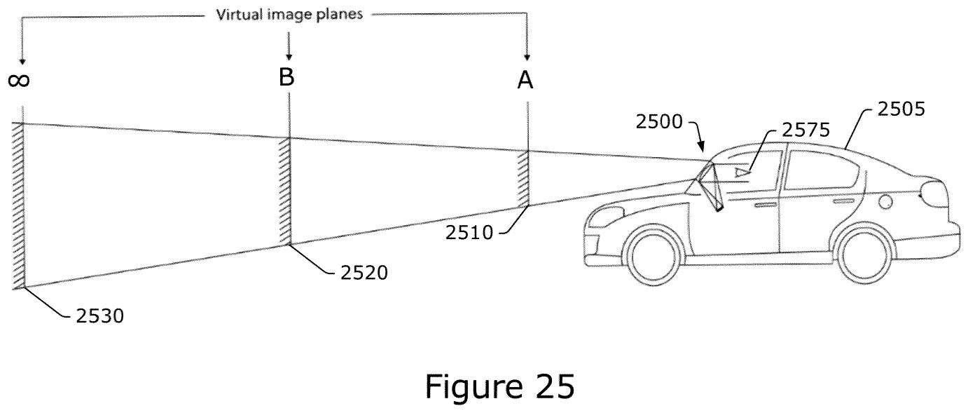

FIG. 1 shows various views of a gyroscopic pointer 111 (also referred to as a “compass pointer 111”, “compass arrow 111”, or the like) displayed by an example HUD user interface (UI) 110, according to various embodiments. The HUD UI 110 may be a transparent screen through which the user of a HUD device (e.g., HUD system 2400 of FIG. 24, HUD system 2500 of FIG. 25, or the like) views an observable world (also referred to as the user's field of view (FoV)). The gyroscopic pointer 111 is a UX/UI element that provides navigation information to the user of the HUD device/system (hereinafter referred to simply as a “HUD”), such as turn-by-turn (TBT) navigation information and/or information leading a vehicle operator inside a maneuver while operating a vehicle (e.g., vehicle 305 of FIG. 3 discussed infra). The gyroscopic pointer 111 may be a (semi-)AR 3D arrow-like object that points where the vehicle operator should guide the vehicle 305. In this example, the gyroscopic pointer 111 is in the shape of a chevron (sometimes spelled “cheveron”), a ‘V’ (or an inverted ‘V’), a dart, or arrowheard, however, the gyroscopic pointer 111 may have any suitable shape such as those shown by FIGS. 22-23. The gyroscopic pointer 111 may be used for unconventional road layouts and/or intersections such as roundabouts and the like.

Perspective view 101 shows the gyroscopic pointer 111 in a neutral orientation, pointing forward from the perspective of a user of the HUD. In view 101 of the gyroscopic pointer 111, a point or vertex of the gyroscopic pointer 111 may be slightly higher than the wing tips of the gyroscopic pointer 111 (with respect to the ground).

Perspective view 102 shows the gyroscopic pointer III in an orientation pointing in a rightward direction from the perspective of a user of the HUD. In view 102, the gyroscopic pointer 111 has moved (or yawed 112) about a yaw axis (not shown) slightly to the right from the neutral position shown by view 101.

Perspective view 103 shows the gyroscopic pointer 111 in an orientation pointing in a more rightward direction than shown by view 102, from the perspective of a user of the HUD. In view 103, the gyroscopic pointer 111 has yawed more to the right from the position shown by view 102, and has also rolled farther in an upward and rightward direction from the perspective view shown by view 102.

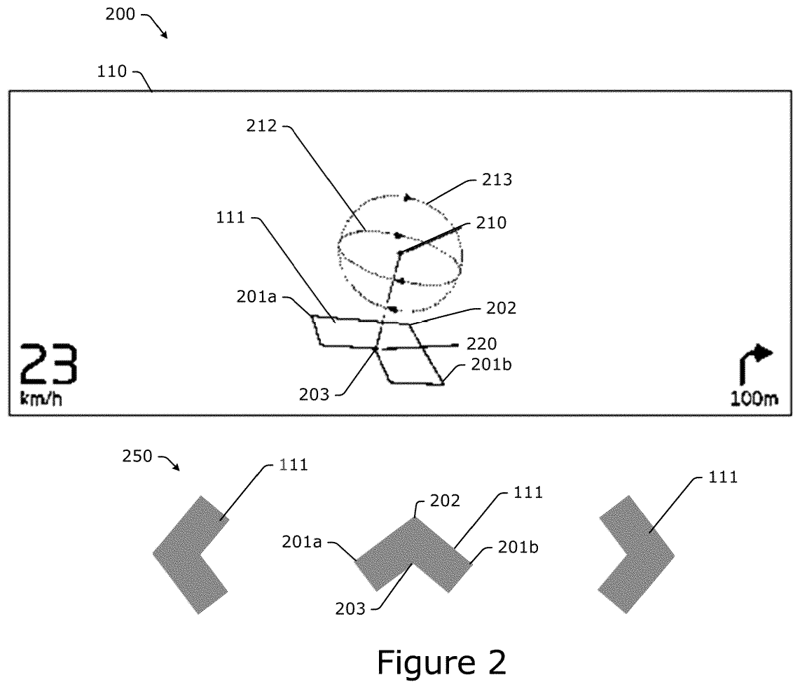

FIG. 2 shows example rotational motions and/or axis rotations 200 of the gyroscopic pointer 111. As shown by FIG. 2, the gyroscopic pointer 111 has two rotation origin points, which create specific rotation mechanics for the gyroscopic pointer 111. The first rotation origin 210 is for yaw rotational motions 212 (or simply “yaw 212”) and roll rotational motions 213 (or simply “roll 213”), and is located at some predefined distance above the gyroscopic pointer 111. In this example, the first rotation origin 210 is located at the predefined distance above a concave vertex 203 of the gyroscopic pointer 111. The first rotation origin 210 may be referred to as a “yaw and roll origin point 210” or the like. The yaw and roll origin point 210 is the pivot point for the yaw 212 and roll 213, and is a disposed at a point above the center of the plane that contains the texture of the pointer 111. The second rotation origin 220 is for pitch rotational motions, and may be referred to as a “pitch origin 220,” “pitch point 220,” or the like. The pitch point 220 is located at the center of the gyroscopic pointer 111, or at the concave vertex 203 of the gyroscopic pointer 111.

In terms of rotational mechanics, the first rotation origin 210 is an origin point for the normal axis or yaw axis (Y) as well as the longitudinal axis or roll axis (Z); and second rotation origin 220 is an origin point for the transverse axis, lateral axis, or pitch axis (X). These axes move with the vehicle 305 and rotate relative to the Earth along with the vehicle 305.

The yaw axis is perpendicular to the gyroscopic pointer 111 with its origin 210 at a predefined distance above the concave vertex of the gyroscopic pointer 111, and directed towards the bottom of the aircraft. The yaw axis is perpendicular to the other two axes. The yaw motion 212 includes side to side movement at the convex vertex 202 of the gyroscopic pointer 111 (i.e., the tip or nose of the gyroscopic pointer 111). Additionally or alternatively, the yaw motion 212 includes side to side movement from the concave vertex 203 of the gyroscopic pointer 111.

The roll axis is perpendicular to the other two axes with its origin 210 at the predefined distance above the concave vertex of the gyroscopic pointer 111. The roll axis extends from the origin 210 longitudinally towards the convex vertex 202 and is parallel with a body of the gyroscopic pointer 111. Stated another way, the roll axis points in the direction that the gyroscopic pointer 111 points. The rolling motion 213 includes up and down movement of the wing tips 201a, 201b of the gyroscopic pointer 111.

The pitch axis is perpendicular to the yaw axis and is parallel to a plane of the wings 201a, 201b of the gyroscopic pointer 111 with its origin 220 at the concave vertex 203 of the gyroscopic pointer 111. A pitch motion (not shown by FIG. 2) is an up or down movement of the convex vertex 202 of the gyroscopic pointer 111.

During operation, the gyroscopic pointer 111 may rotate (e.g., yaw 212, roll 213, pitch) in response to TBT navigation information provided by a mapping service, navigation app, or route planning app as the user as the user (or user's vehicle 305) arrives at, or approaches, various waypoints along a desired route. In various embodiments, the gyroscopic pointer 111 continuously rotates to display TBT direction information to navigate towards and through a maneuver point. In particular, the gyroscopic pointer 111 continuously rotates as the vehicle 305 travels along the desired route. As the vehicle 305 is traveling, the gyroscopic pointer 111 points towards or at a direction in which to navigate. The behavior of the pointer 111 is that it shows where the vehicle 305 operator needs to navigate towards in the near future so she/he can anticipate a particular vehicle 305 maneuver prior to actually performing the maneuver itself.

In some implementations, the pointer 111 remains in the same position and in the UI of the HUD, and does not float around the user's FoV during operation. In some AR-based navigation systems, the directional arrows may move around the display screen, which may cause operator confusion and/or operator error. By contrast, in these implementations, the pointer 111 stays in the same position within the FoV, but changes its orientation by continuously rotating about the origins 210 and 220, which reduces operator confusion and operator error.

There are several aspects and parameters that can be fine-tuned or otherwise adjusted to achieve a suitable UX to avoid or reduce user confusion during vehicle operation. Some of these aspects and parameters include coupled yaw 212 and roll 213 motions, rotation angle differentials, rotation angle limits, and/or the like.

In embodiments, the yaw 212 and roll 213 motions of the pointer 111 are coupled to one another. In these embodiments, the yaw 212 and roll 213 are connected such that the yaw 212 and roll 213 take place at the same time and/or by the same or similar amounts. In one embodiment, a change in the yaw 212 causes or results in a same change in the roll 213, or vice versa, for example, if the yaw 212 changes by X degrees (°), then the roll 213 changes by X°, where X is a number. Additionally or alternatively, a scaling factor may be applied to the yaw 212 or the roll 213 to increase or decrease the amount of rotation. In one example, when the yaw 212 changes by X°, then a scaling factor S is applied to the roll 213 (e.g., where the roll 213 changes by S+X° or S×X°, where X and S are numbers). In another example, when the roll 213 changes by X°, then the scaling factor S is applied to the yaw 212 (e.g., where the yaw 212 changes by S+X° or S×X°, where X and S are numbers). These embodiments may provide a more “natural” rotation from the user's perspective that make understanding the intended TBT direction information easier than those provided by conventional/existing HUD navigational applications.

In various embodiments, the rotation angle differentials may be predefined or configured. In these embodiments, the rotation angle(s) may be set to a predefined threshold or range of angles, such as between 30°-45°. In these embodiments, the pointer 111 yaws 212 and rolls 213 by the set rotation angle for each TBT direction change. Furthermore, the rotation angle may be adjusted based on user parameters (e.g., eye sight ability, seated/torso height, etc.), road/travel conditions, road layout, and/or other like parameters. These adjustments may be made so that the FoV inside the UI is at a suitable/proper angle for the user to correctly understand where to navigate the vehicle 305.

In various embodiments, a limiter may be used to prevent the pointer 111 from being oriented in a manner that is confusing or unviewable to the user. In one example, the limiter may prevent the pointer 111 from having a 0° orientation about the Y axis as is shown by view 250. In this example, a top portion of the pointer 111 faces the users gaze, which may appear to be stuck in the same position for a long time, and the user may believe that the navigation app has crashed or is otherwise not working properly. In another example, the limiter may prevent the pointer 111 from having a 90° orientation about the Y axis (e.g., completely horizontal with respect to the ground, or pointing directly into the page/sheet including FIG. 2), a 180° orientation about the Y axis (e.g., pointing directly at the driver), and/or from having a 90° orientation about the X axis (e.g., completely vertical with respect to the ground). These rotation angles would cause the pointer 111 to be invisible to the user. In another example, the limiter may prevent the pointer 111 from having a orientation about the Y axis. In either of these embodiments, the limiter may fade the rotation as the pointer 111 reaches the predefined limit(s). The fading may involve slowing the rotation speed as the pointer 111 gets closer to the limited rotation angles. In this way, the pointer 111 may appear to be slightly rotated so it does not seem stuck during operation.

Additionally or alternatively, the parameters of any of the aforementioned embodiments may be dynamically adjusted based on road/travel conditions. In these embodiments, the HUD app includes logic that will create dynamic parameters and it will change the various pointer 111 parameters dynamically depending on the road curvature, environmental conditions (e.g., overcast versus sunny conditions), the number of navigation options for proceeding towards a desired destination (e.g., number of exits off of a highway or roundabout, etc.). The dynamic adjustment of these parameters may improve the precision of the pointer 111 when providing TBT navigation information.

The aforementioned embodiments provide unique UX/UI behaviors to the pointer 111 including the appearance that the pointer 111 is floating in the air in front of the user or vehicle 305, whereas existing navigational arrows only have the appearance of rotating on a flat surface. The floating appearance provides a more intuitive UX, which prevents and/or reduces operator confusion and error during vehicle operation. The prevention and reduction of operator confusion and error may reduce the amount of time the user is operating the vehicle 305, thereby reducing traffic congestion, the likelihood of traffic collisions, and reducing fossil fuel emissions.

FIG. 3 shows an example gyroscopic navigation pointer operational scenario 300 according to various embodiments. In operational scenario 300, a vehicle 305 is traveling along a road bounded by roadsides 302a, 302b, and including lane markers 303 through the middle of the road. The vehicle 305 may be the same or similar as vehicle 2505 of FIG. 2500 and may implement a HUD device such as HUD or the like. The HUD (or an operator of vehicle 305) has a field of view (FoV) 310 through which the user/operator of the vehicle 305 can view the gyroscopic navigation element 111.

The FoV 310 is the extent of the observable world that can be seen by the user within the vehicle 305. For purposes of the present disclosure, the FoV 310 is the view that is observable through the transparent screen of the HUD system, such as the HUD UI 110 of FIGS. 1 and 2, the screen 2407 of FIG. 24, and/or the like. In general, the FoV 310 may be defined as the number of degrees of a visual angle. In some implementations, the FoV 310 may be 8°×4° to 12°×5°. In this example, the FoV 310 may allow the pointer 111 to appear as if it is floating approximately 15 meters (m) in front of vehicle 305.

In most scenarios, including the operational scenario 300, the entire road surface is not covered by the FoV 310, and therefore, the pointer 111 guides the user/operator of the vehicle 305 where to navigate the vehicle 305. Existing HUD navigation UIs use directional arrows with several fixed positions and orientations and merely animate transitions between these different directional arrows to indicate a particular maneuver at a maneuver point. The pointer 111 of the embodiments herein does not merely indicate a particular maneuver to perform. Instead, the pointer 111 continuously rotates/moves to always point at an upcoming maneuver point and/or to point in the direction the vehicle 305 needs to go as the vehicle 305 travels along the desired route. For example, in FIG. 3, the pointer 111 does not merely indicate that the turn is upcoming; rather, the pointer 111 will continue to rotate and point towards the turn (curve in the road shown by FIG. 3) as the vehicle 305 gets closer to the turn and as the vehicle's 305 position and orientation changes with respect to maneuver point (e.g., where the turn is to take place).

In various embodiments, the pointer 111 points at a target point 330 (also referred to as a “target position 330”) that is disposed on the planned route and/or on a smoothed route spline 325. The target point 330 may be disposed on the route or spline 325 at a predetermined or configured distance from the vehicle 305. In some implementations, the pointer 111 orientation (e.g., yaw and roll angles) is updated every Z number of (video) frames (where Z is a number). In some implementations, the pointer 111 orientation (e.g., yaw and roll angles) is updated after each (video) frame is displayed providing a more precise and more natural way of showing TBT information.

In these embodiments, the HUD app/logic generates the smoothed route spline 325 based on a generated route spline 320. The HUD app/logic may create the route spline 320 based on the journey/route data provided by a suitable mapping service and/or journey planning service. The HUD app/logic may then use a suitable smoothing algorithm to create the smoothed route spline 325 from the route spline 320.

In some implementations, the journey/route data of the desired route/journey may comprise a plurality of waypoints. Waypoints are unique addresses for any point in the world using coordinate units such as latitude and longitude, GNSS/GPS coordinates, US National Grid (USNG) coordinates, Universal Transverse Mercator (UTM) grid coordinates, and/or the like. A series of waypoints can be used to determine a particular trajectory for a vehicle 305 where the trajectory planner defines the control input to reach the next waypoint smoothly. The waypoints are used to describe the trajectory of a vehicle 305 in a curved road segment. In some embodiments, one or more waypoints may be, or may indicate, a maneuver point.

In the example of FIG. 3, the spline 320 is used to link waypoints provided by the trajectory planner. In this example, the verteces between each line of the spline 320 may be an individual waypoint. The term “spline” may refer to various types of data interpolation and/or smoothing functions. A spline 320 may represent segments of linear projections by piece-wise polynomial functions that can be modified to fit the constraints of a projected path or terrain map/model. In one implementation, the HUD app/logic may use a smoothing/spline function to fit a spline 320 directly on the modeled terrain to traverse the path. In another implementation, he HUD app/logic may use a smoothing/spline function to generate a piece-wise continuous path (e.g., linear projections) and fitting a curve to that path. Various aspects related to generating the spline 320 are discussed in Boyd et al., “Convex Optimization”, Cambridge University Press (March 2004), which is hereby incorporated by reference in its entirety. In another implementation, the HUD app/logic may use parametric representation to generate the spline 320. Parametric representation involves using parametric equations to express the coordinates of the points that make up a curve. In embodiments, the parametric representation may be or include Frenet-Serret frames (or simply “Frenet frames”), which describe the kinematic properties of a particle or object moving along a continuous, differentiable curve in 3D Euclidean space. In these embodiments, the vehicle 305 trajectory is mainly represented through the derivatives of tangent, normal, and binormal unit (TBN) vectors of the trajectories. In addition, the accuracy of the trajectory representation can be selected based on the underlying driving conditions.

Regardless of how the HUD app/logic generates the spline 320, in some implementations, resulting positions of pointers 311 are modified (or re-positioned) at or near the maneuver point, which makes pointers 311 more distant and prevents the vehicle 305 from driving into or over the roadside 302. In these embodiments, the modification or re-positioning of the pointers 311 may be based on the map quality. For example, where high definition maps or other high quality maps are used, the pointers 311 can be re-positioned to the road boarders 302 for positioning with some additional shift for position uncertainty. In implementations where standard definition maps are used, another smoothing function may be used to generate the smoothed route spline 325 from the route spline 320 so as to remove the edges and/or sharp angles from the route spline 320. In these implementations, additional distance may be added to the maneuver point for somewhat inaccurate maps. Any suitable smoothing algorithm may be used to generate the smoothed route spline 325. However, some smoothing algorithms may cut one or more edges too much, which could cause corners around turns to be cut too much. This may cause the smoothed route spline 325 and the target point 330 to veer off the roadway, thereby causing the pointer 111 to point at an incorrect position. In one example implementation, a weighted-moving average algorithm may be used for the smoothing and “knees” may then be added at or near the maneuver point.

Once the smoothed route spline 325 is created, the HUD app/logic generates a target point 330 on the smoothed route spline 325 at a predetermined distance along the travel route. In one example implementation, the target point 330 may be disposed at 50 m from the vehicle 305 along the planned route or a straight line distance regardless of the vehicle 305 trajectory. Other distances may be used in other embodiments.

As the vehicle 305 travels along the desired route, the target point 330 also moves along the desired route, maintaining the predetermined distance between the target point 330 and the vehicle 305. Additionally, the pointer 111 continuously points at the target point 330 as the vehicle 305 and the target point 330 travel along the desired route, which causes the pointer 111 to continuously rotate according to the planned trajectory of the vehicle 305. In these ways, the target point 330 connects the pointer 111 in the FoV 310 with the road and the real world.

Additionally or alternatively, the distance to the target point 330 could be dynamic based on different road situations and/or road conditions. In one example, the distance between the target point 330 and the vehicle 305 may be shortened when the vehicle 305 is about to navigate through or around a specific object or obstacle (e.g., a roundabout, road construction area, or the like), and then lengthened after the vehicle 305 negotiates the obstacle. In another example, the distance between the target point 330 and the vehicle 305 may be shortened when the vehicle 305 is navigating through dangerous environmental conditions, and then lengthened after the environmental conditions become more favorable.

Additionally or alternatively, the HUD app/logic may include offset logic to align the smoothed spline 325 with the vehicle 305. This may be advantageous for operation on multi-lane roads, such as highways and the like. When operating the vehicle 305 on a road with two, three, four, or five lanes (including lanes for only one travel direction or different travel directions), the smoothed spline 325 may be projected into the center of the road (within some margin of error) along with the target point 330. However, when the vehicle 305 is driving in the left most lane, the pointer 111 may point to the center of the road since the target point 330 is also projected into the center portion of the road. For example, when driving in a straight line in a left most lane of a multi-lane road, the pointer 111 may inadvertently point towards the center of the road. The offset logic may be used to avoid these issues by aligning the smoothed spline 325 with the position of the vehicle 305, for example, making the HUD app/logic “think” the vehicle 305 is always on top of the smoothed spline 325. In this way, the pointer 11 only reacts to the curvature of the smoothed spline 325, but not the position of the spline with respect to the vehicle 305.

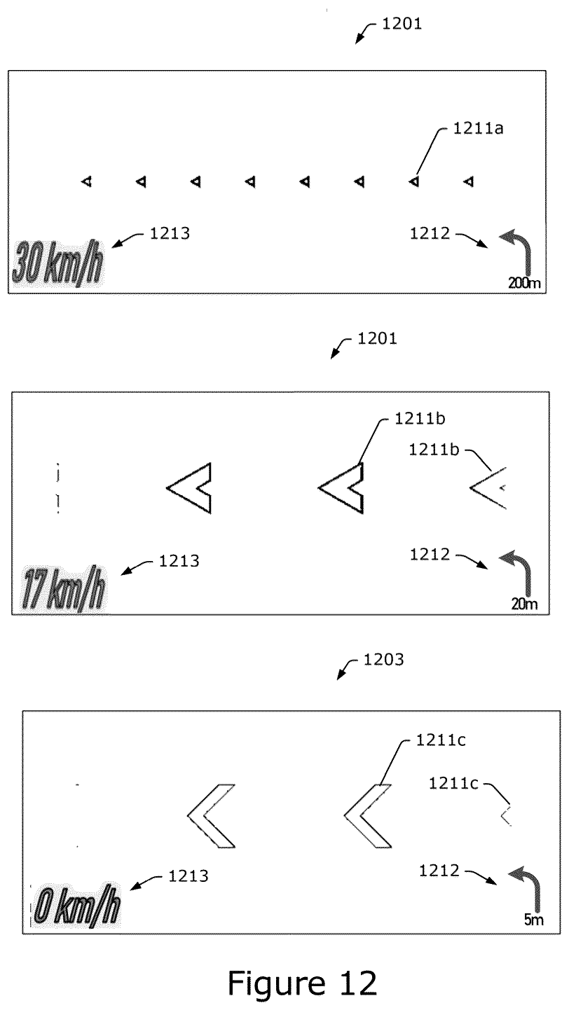

It should be noted that the point in time or space (e.g., location) at which the HUD app/logic generates the splines 320, 325 and the target point 330 and/or generates and renders the pointer 111 may be based on specific use cases, user-configured/selected preferences, learnt user behaviors, and/or design choice, and may vary from embodiment to embodiment. In one example, the pointer 111 may be displayed only when the vehicle 305 reaches a predetermined distance from the maneuver point at which the pointer 111 is to point. In this example, different pointers may be displayed (see e.g., FIGS. 12-27) based on each upcoming maneuver and maneuver point. In another example, the pointer 111 may be displayed continuously regardless of the relative distance between the vehicle 305 and the maneuver point at which the pointer 111 is to point. In this example, the pointer 111 may be displayed between specific maneuvers such as turns, navigating around roundabouts, and the like.

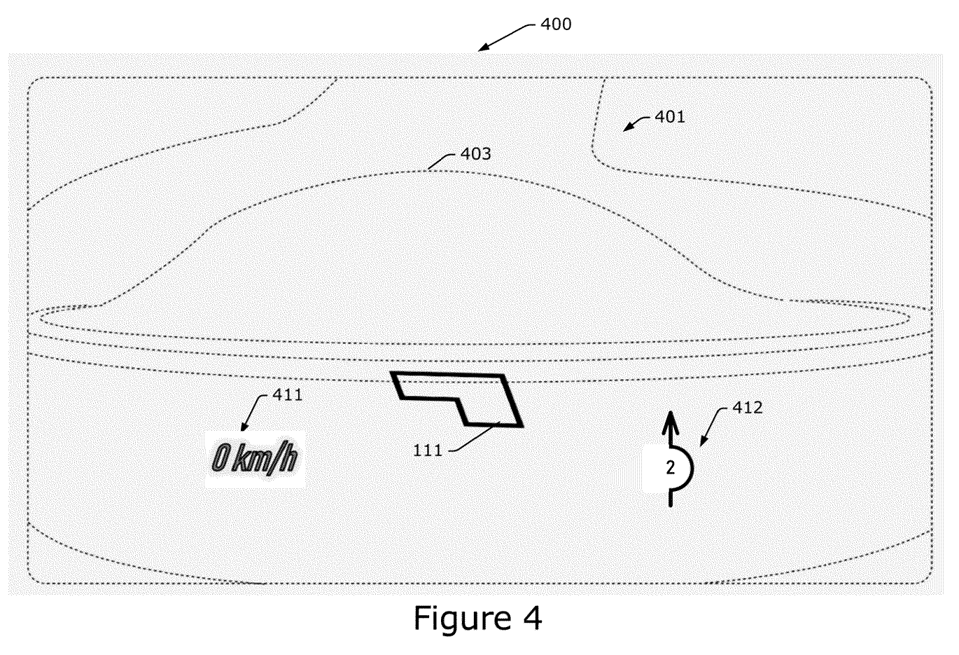

FIGS. 4-11 show various UIs that may be displayed by a vehicular HUD system/device (e.g., HUD 2400 or HUD 2500 of FIGS. 24 and 25) as the vehicle 305 performs maneuvers at and around a roundabout 401. In FIGS. 4-11, the broken lines represent the display screen of the HUD and real objects viewed through the display screen of the HUD, and the solid lined objects represent graphical objects (also referred to as “GUI elements” and the like) projected onto the display screen by the HUD. The entire scene/view viewed through the display screen may represent the FoV 310 at a certain point in time.

The various UIs 400-1100 in FIGS. 4-11 comprise a number of graphical objects related to navigation information displayed by the HUD. The graphical objects in FIGS. 4-11 are shown in various states as the vehicle 305 including the HUD performs different maneuvers. These graphical objects include the gyroscopic pointer 111, a speedometer object 411, and a TBT object 412. The speedometer object 411 displays a current travel speed/velocity of the vehicle 305 and the TBT object 412 indicates a TBT direction and/or a specific maneuver that the driver of the vehicle 305 is to perform in accordance with the desired route. In some implementations, the objects 411 and 412 may be tilted to have a perspective view, and may have several animations or other display effects to change their appearance during the journey. In the example of FIGS. 4-11, the TBT object 412 indicates that the driver is to enter and navigate through a roundabout 401, where the digit(s) within the half-circle portion of the TBT object 412 indicates a particular exit that the vehicle 305 should take out of the roundabout 401 (e.g., the number two (2) in the example of FIGS. 4-11 indicates that the driver should take a second exit out of the roundabout 401).

FIG. 4 shows a UI 400 including a first perspective view of the gyroscopic pointer 111 as the vehicle 305 approaches the roundabout 401. The roundabout 401 (also referred to as a “gyratory system,” a “gyratory,” or the like) is a circular intersection or junction in which road traffic is permitted to flow in one circular or gyratory direction, where priority (or “right-of-way”) is typically given to traffic already in the junction. The roundabout 401 may include a traffic island 403 to alert approaching drivers to the presence of the roundabout 401, and to encourage drivers to focus on the traffic in the path of the circle. The traffic island 403 may include, for example, monuments, art installations, fountains, pedestrian crossings, buildings, and/or the like. Due to such physical barriers, when the vehicle 305 enters (or is about to enter) the roundabout 401, most of the roundabout's 401 road surface is outside of the FoV 310 of the HUD. Since most of the roundabout 401 is outside the FoV 310, the gyroscopic pointer 111 is used to guide the vehicle 305 through the roundabout 401.

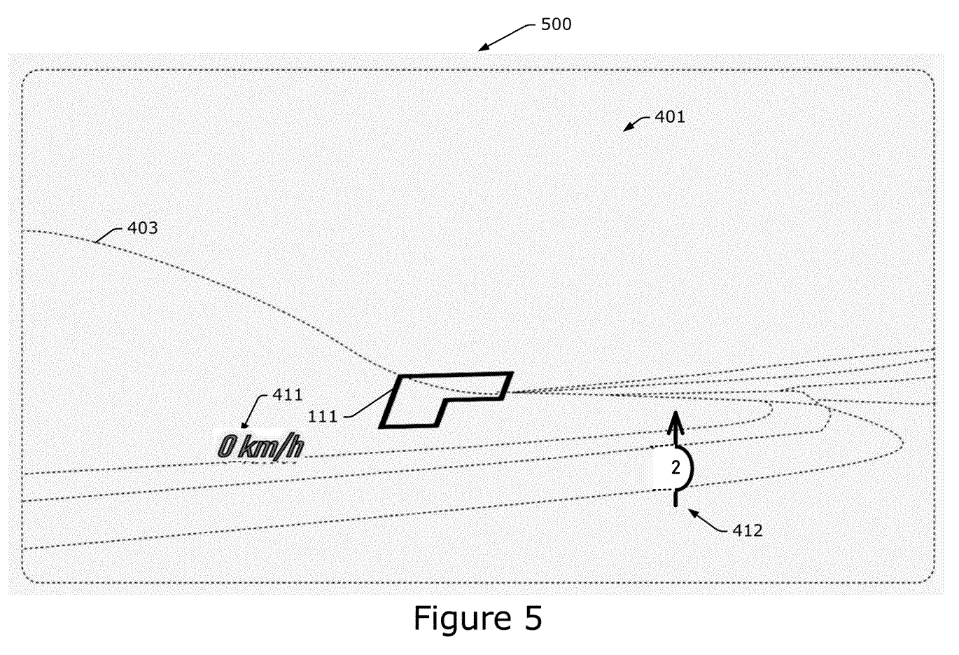

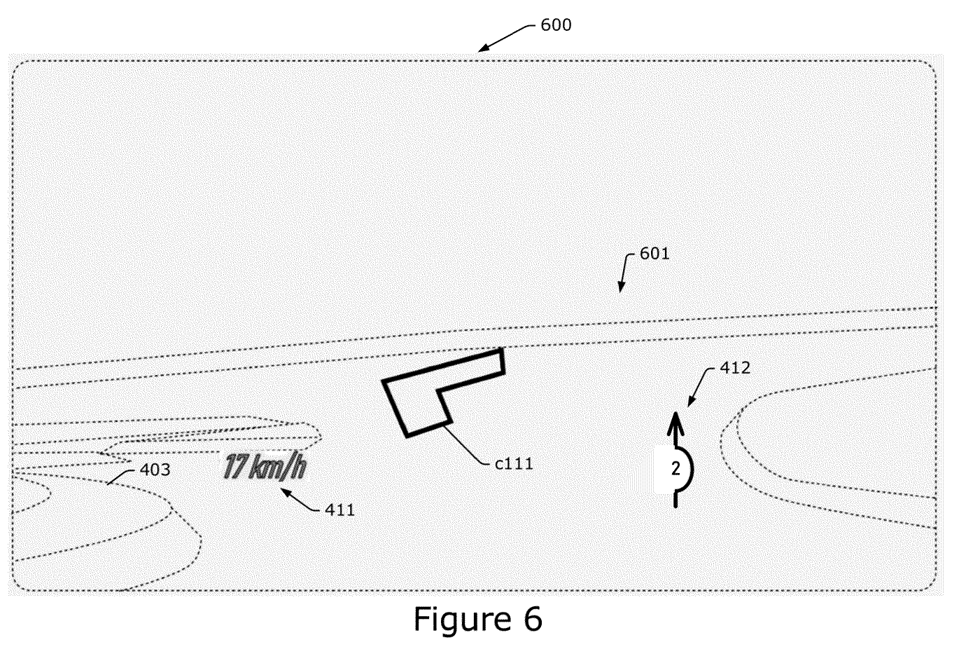

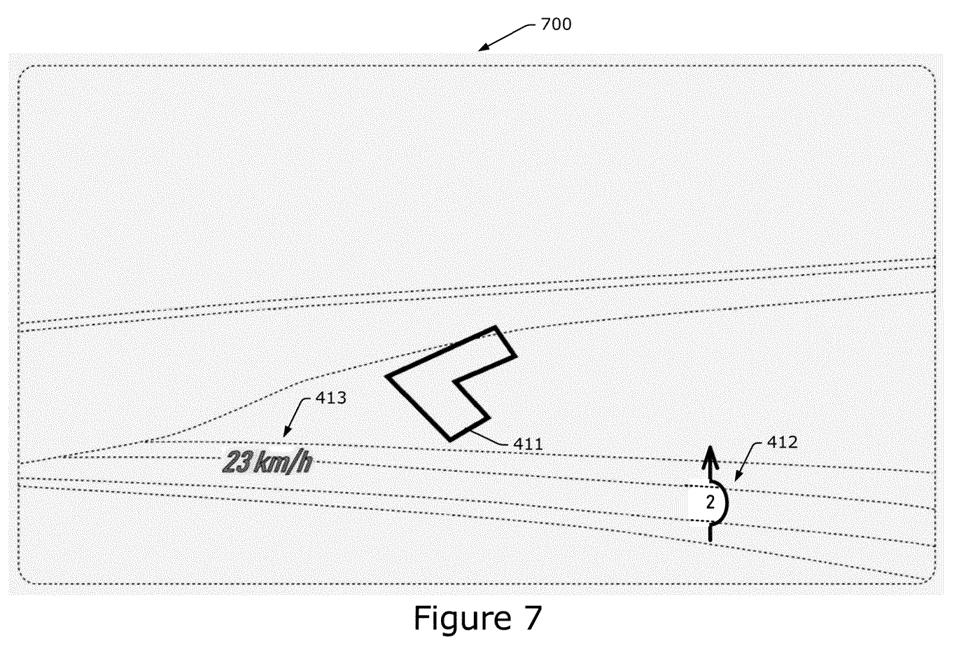

FIG. 5 shows a UI 500 including a second perspective view of the gyroscopic pointer 111 as the vehicle 305 enters the roundabout 401. FIG. 6 shows a UI 600 including a third perspective view of the gyroscopic pointer 111 as the vehicle 305 proceeds around the roundabout 401. UI 600 shows the gyroscopic pointer 111 indicating to continue around the roundabout 401, passing a first roundabout exit 601. FIG. 7 shows a UI 700 including a fourth perspective view of the gyroscopic pointer 111 as the vehicle 305 continues to proceed around the roundabout 401.

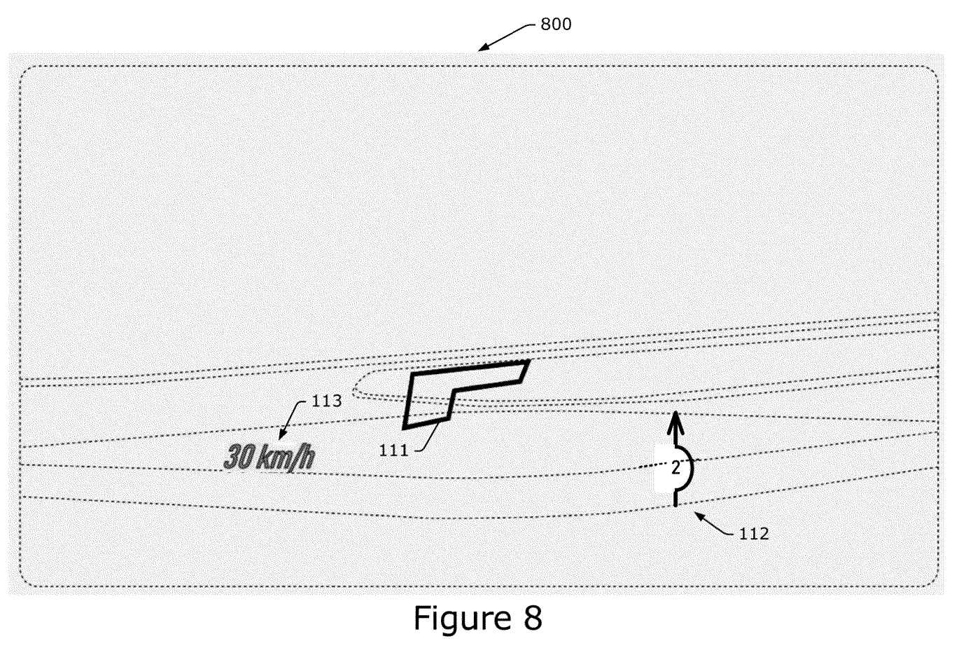

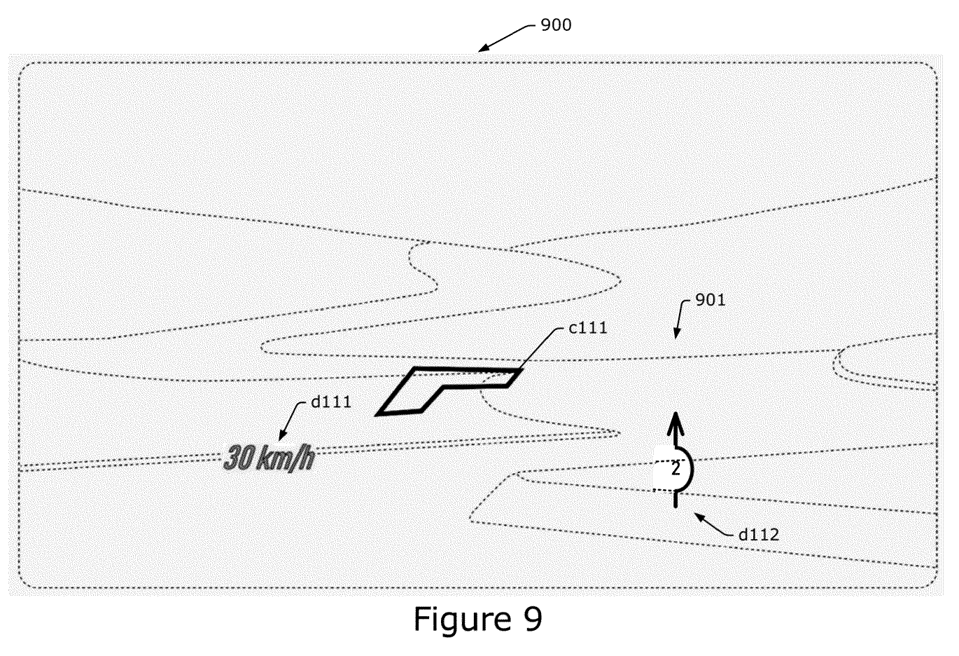

FIGS. 8 and 9 show UIs 800 and 900 including a fifth and sixth perspective views of the gyroscopic pointer 111 as the vehicle 305 continues to proceed around the roundabout 401. UIs 800 and 900 show the gyroscopic pointer 111 yaw 212 and rolling 213 towards the second roundabout exit 901 (shown by FIG. 900).

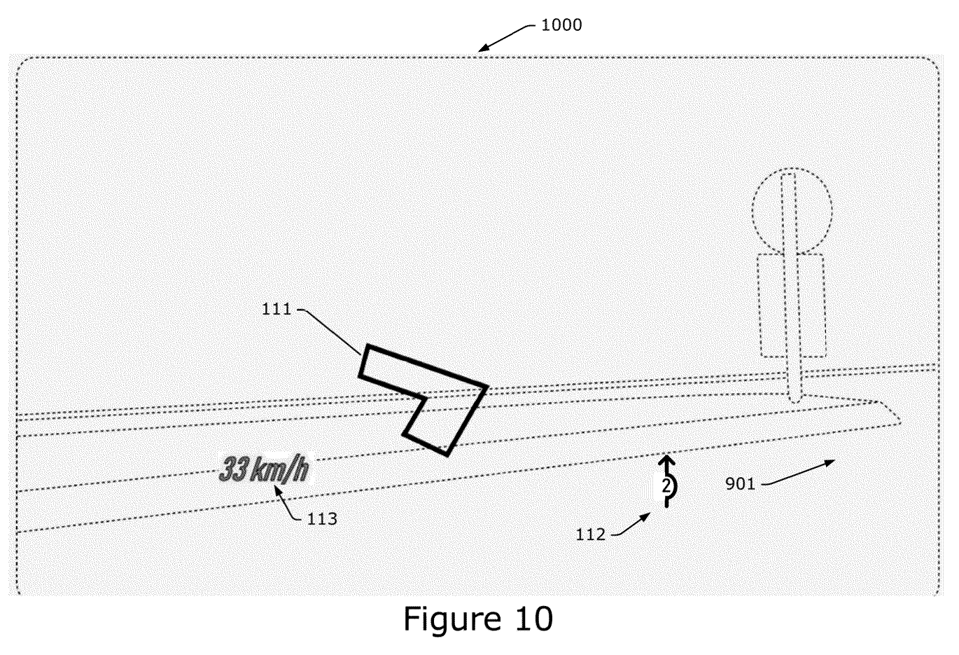

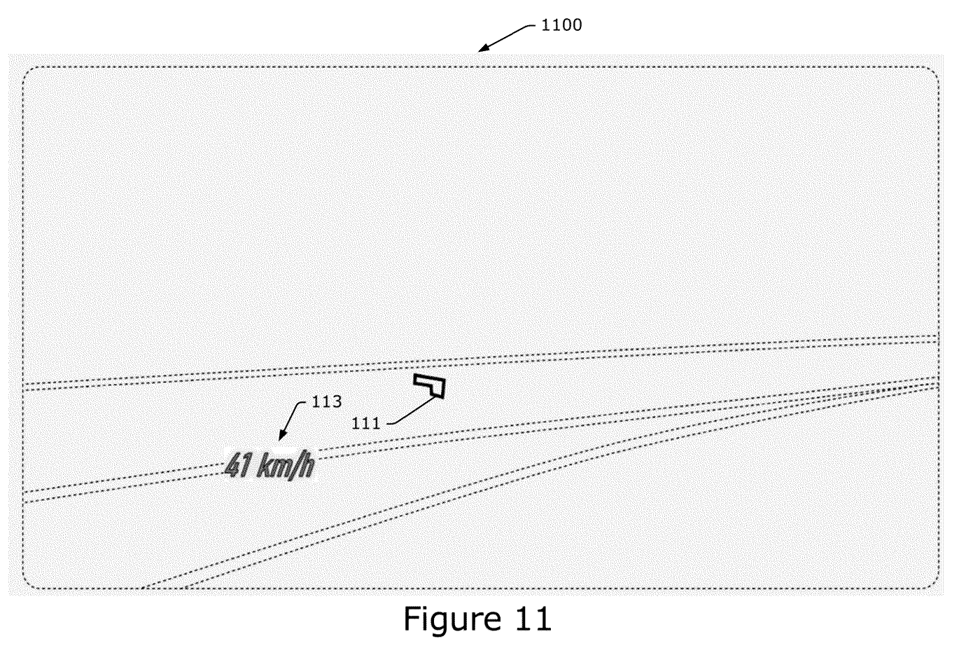

FIG. 10 shows a UI 001 including a seventh perspective view of the gyroscopic pointer 111 as the vehicle 305 is about to exit the roundabout 401 through the second roundabout exit 901. FIG. 11 shows a UI 1100 including a eighth perspective view of the gyroscopic pointer 111 as the vehicle 305 is exiting the roundabout 401. As the vehicle 305 is exiting the roundabout 401, the gyroscopic pointer 111 and the TBT object 412 may be closed or otherwise removed from the display screen. For example, in FIG. 10 the TBT object 412 is shown as being minimized, and then disappeared in FIG. 11. Furthermore, the gyroscopic pointer 111 is shown as being minimized in FIG. 11, which may then be removed from the display screen as the vehicle 305 proceeds along the travel route.

Conventional TBT navigation systems may include TBT GUI elements similar to the TBT object 412 to indicate navigation through roundabout 401. Usually, these TBT GUI elements include some indication of a direction the driver should take to leave the roundabout 401, such as an arrow indicating to continue straight, turn left, or turn right out of the roundabout 401, or a street name to take out of the roundabout 401. However, such TBT GUI elements in a UI layout do not accurately or adequately indicate the shape of the roundabout 401 (e.g., a circle versus an ellipsis shape), the length of the roundabout 401, the number of exits of a particular roundabout 401, the position of individual exits in the roundabout 401, and/or the like. These TBT GUI elements cannot be used to show a proper visual progression of where the vehicle 305 needs to go while the vehicle 305 passes through the roundabout 401 towards the correct exit. This may lead to user confusion and result in the driver taking the wrong exit out of the roundabout 401. These issues may be exacerbated when a roundabout 401 has an unconventional shape and/or exits positioned in an unconventional manner (see e.g., the Chiverton Cross roundabout in Three Burrows, Truro, Cornwall, England, U.K., the Magic Roundabout in Swindon, England, U.K., or the “Peanut-Shaped” roundabout in Nozay, France), and/or when many obstructions surround the roundabout 401 (see e.g., Dupont Circle in Washington, D.C., U.S.A.).

Additionally, some TBT navigation systems display conventional directional arrow GUI elements through roundabouts 401 in order to guide the driver to the correct exit. However, these conventional directional arrow GUI elements do not account for the circular or elliptical shape of most roundabouts 401, which may also may lead to user confusion and result in the driver taking the wrong exit out of the roundabout 401. For example, as a vehicle 305 travels through a roundabout 401, a conventional directional arrow GUI element may display an arrow with a right-angled tail to indicate a particular direction to travel around the roundabout 401. However, when the vehicle 305 is a quarter of the way through the roundabout 401, the conventional directional arrow GUI element is already positioned/oriented in an incorrect position/orientation with respect to the road path. The gyroscopic pointer 111 embodiments discussed herein improve the user experience and provide more intuitive TBT indications than the convention TBT navigation systems by indicating the travel path with more granularity and in a more fluid and efficient manner than the convention TBT navigation systems.

Furthermore, conventional TBT navigation systems do not account for the physical actions/tasks undertaken by most drivers when negotiating roundabouts 401, which often require motorists to look to the rear and from side-to-side during different points within the roundabout 401. The gyroscopic pointer 111 embodiments discussed herein provide more awareness of the maneuvers to be performed than conventional TBT navigation systems, which can be seen in most motorists' peripheral vision when looking around while navigating through a roundabout 401.

Although the example embodiments of FIGS. 4-11 are described for negotiating a roundabout 401, it should be noted that the pointer 111 could be used for any other type of maneuver such as hard turns (e.g., 90° or more), slight or soft turns (e.g., less than 90°), U-turns, merging onto a road (e.g., highway), exiting a roadway (e.g., a highway), changing lanes, veering in a particular direction, braking, accelerating, decelerating, and/or the like.

### 2. Directional Pointers

FIG. 12 shows various views of directional pointers 1211 (including pointers 1211a-1211c) displayed by example HUD UIs 1201, 1202, and 1203, according to various embodiments. Note that not all the pointers 1211a, pointers 1211b, and pointers 1211c, are labeled in FIG. 12 for the sake of clarity. The UIs 1201, 1202, and 1203 may be the same or similar as the HUD UI 110 discussed previously. The directional pointers 1211 (also referred to as “turn-by-turn pointers,” “TBT pointers,” “navigation pointers,” or the like) are UX/UI elements that provide navigation information to the user of the HUD, such as turn-by-turn (TBT) navigation information and/or information leading a vehicle operator inside a maneuver.

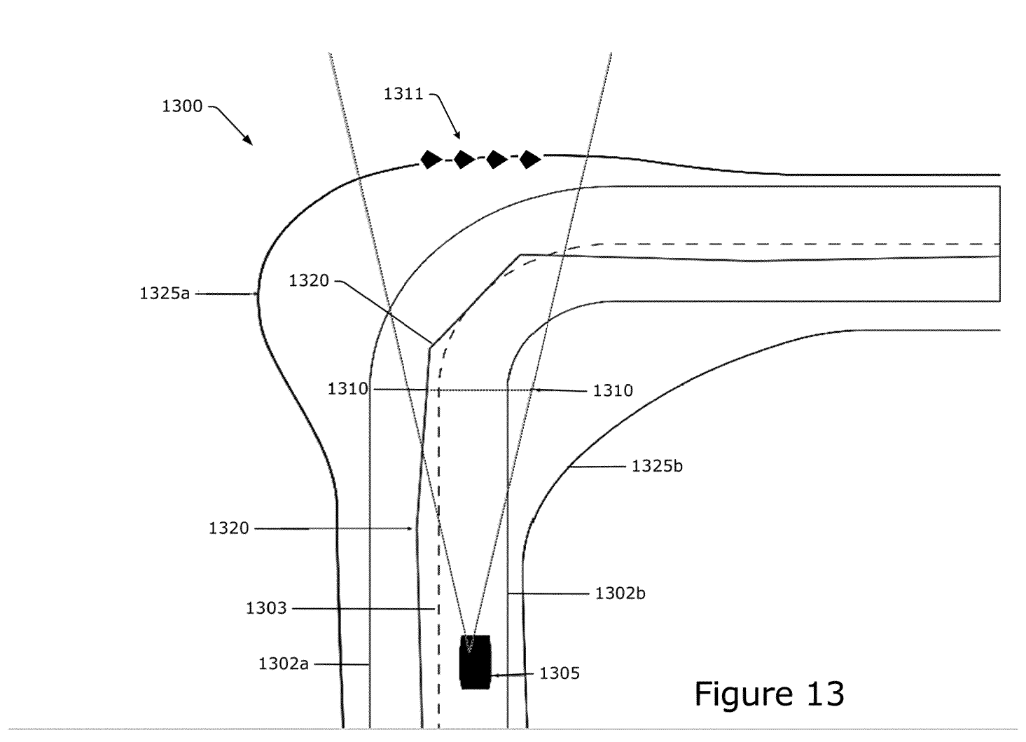

The directional pointers 1211 may be (semi-)AR 3D arrow-like objects that point where the vehicle operator should guide the vehicle (e.g., vehicle 1305 of FIG. 13 discussed infra). In this example, the directional pointers 1211 are in the shape of triangles, chevrons, ‘V’'s (or an inverted ‘V’), darts, or arrowheards, however, the directional pointers 1211 may have any suitable shape such as those shown by FIGS. 22-23.

The directional pointers 1211 are used to guide the driver from short distances and through the inside of a maneuver (e.g., left or right turns, and the like). The directional pointers 1211 indicate upcoming maneuvers as indicated by mapping data or TBT data provided by a mapping service or navigation system implemented by the vehicle 1305 (or HUD). The directional pointers 1211 also indicate how the user should negotiate/navigate the indicated maneuver during the maneuver itself. In embodiments, the HUD uses the mapping data and/or TBT information to place the directional pointers 1211 at a maneuver point within the GUI layer of the FoV (see e.g., (e.g., FoV 1310 of FIG. 13). The maneuver point is a location or position where the indicated maneuver is supposed to take place. The maneuver point may be based on a geolocation and/or GNSS coordinate of where the maneuver is to take place, or based on a relative distance from the vehicle 1305 (or HUD) itself.

The UIs 1201, 1202, and 1203 also include a TBT object 1212 and a speedometer object 1213, which may be the same or similar to the speedometer object 411 and the TBT object 412 discussed previously. In some implementations, the objects 1212 and 1213 may be tilted to have a perspective view, and may have several animations or other display effects to change their appearance during the journey. In the example of FIG. 12, the TBT object 1212 indicates that the vehicle 1305 is approaching a left turn, where the digit(s) underneath the TBT object 412 indicates an estimated distance to the upcoming left turn (e.g., 200 meters (m) in UI 1201, 20 m in in UI 1202, and 5 m in UI 1203). Additionally, the directional pointers 1211 are shown pointing in a leftward direction with respect to the travel direction of the vehicle 1305 (or HUD) (e.g., into the page in the example of FIG. 12), indicating that a left turn is upcoming.

In various embodiments, the shape and/or size of the directional pointers 1211 dynamically changes as the vehicle 1305 (or HUD) approaches the indicated maneuver. For example, in FIG. 12, eight relatively small directional pointers 1211a are shown in UI 1201 when the vehicle 1305 (or HUD) is at about 200 m away from the left turn. These relatively small directional pointers 1211a are still recognizable to most users and provide a sufficient indication of when the turn is to take place, while providing minimal obstruction of the user's FoV (e.g., FoV 1310 of FIG. 13). As the vehicle 1305 (or HUD) gets closer to the left turn, the HUD displays two to three larger chevron pointers 1211b as shown in UI 1202. Then, when the vehicle 1305 (or HUD) is at or near the left turn, the HUD displays two to three differently shaped chevron pointers 1211c as shown in UI 1203. The larger pointers 1211b-c and the changing shape of the pointers 1211 may grab the user's attention to better ensure that the user is aware of the upcoming maneuver. In this example, the pointers 1211c have thinner wings than the pointers 1211b in order to still maintain the user's attention while obscuring less of the user's FoV 1310 left before (and during) the maneuver.

In addition to changing the shape and/or size of the pointers 1211, various animations and/or display effects may be used in improve or enhance the UX/UI. In some embodiments, the pointers 1211 have a dynamic texture that changes based on the distance between the vehicle 1305 (or HUD) and the maneuver point. This is made to improve the readability of the pointers 1211. For example, a first texture may be applied to the pointers 1211 at farther distances from the maneuver point, and as the vehicle 1305 (or HUD) gets closer to the maneuver point, a second texture may be applied the pointers 1211. A suitable transition may be definted to switch between the first and second textures. As alluded to previously, the first texture may be more opaque than the second texture to improve viewability of the pointers 1211 at farther distances, and the second texture may be more transparent than the first texture so that real world objects behind the pointers 1211 are not obstructed by the pointers 1211.

In some embodiments, different flashing or blinking effects may be applied to the pointers 1211 based on the distance between the vehicle 1305 (or HUD) and the maneuver point (e.g., the position where the maneuver is to take place). In one example, the flashing/blinking effects may be applied in a directional manner such that a left most pointer 1211 may flash/blink first, then the next left most pointer 1211 may flash/blink, and so forth until the left most pointer 1211. This effect may be reversed for left turn indications (e.g., where the pointers 1211 point to the left in the FoV 1310).

In various embodiments, the directional pointers 1211 may only be visible at a certain viewing angles. For example, the directional pointers 1211 may be completely viewable (e.g., 1001% opaque) when a viewing angle is about 90°, and the opacity of the directional pointers 1211 decreases (or the transparency increases) as as the viewing angle gets sharper (or more acute). For example, in FIG. 12, the directional pointers 1211 are 100% viewable since the FoV 1310 is at about 90° with respect to the direction in which the pointers 1211 are pointing. In this way, the directional pointers 1211 appear only where the driver needs the TBT information and do not unnecessarily obstruct the FoV 1310. Any suitable texture mapping method may be used to apply various textures to the pointers 1211.

Moreover, the pointers 1211 will be displayed by the HUD based on the TBT information provided by a mapping service, but will also be displayed when the vehicle 1305 travels where mapping data does not exist and/or when the vehicle 1305 deviates from the planned route. In one example use case, the vehicle 1305 is navigating through small side-streets or alleyways for which no mapping data exists and/or the mapping service does not have data for suitable maneuvers along these roads/alleys. In this example, the HUD will display the pointers 1211 showing the driver the correct direction to follow along the roads/alleys.

In a second example use case, the vehicle 1305 exits a highway where a fork in the road is just off of the exit, and the mapping data for ta planned route indicates that the vehicle 1305 needs to take a sharper turn at the fork. In this example, the HUD will display the pointers 1211 crossing the driver's line of sight and showing the driver the sharper turn to take.

In a third example use case, the vehicle 1305 pulls over to a rest stop or a gas station, and when the vehicle 1305 exits the rest stop or gas station, the HUD will display the pointers 1211 indicating the path towards the main road and/or planned route.

FIG. 13 shows an example directional pointer operational scenario 1300 according to various embodiments. In operational scenario 1300, a vehicle 1305 is traveling along a road bounded by roadsides 1302a and 1302b and including lane markers 1303. The vehicle 1305 may be the same or similar as vehicle 305 of FIG. 3 and/or vehicle 2505 of FIG. 2500, and may implement a HUD with an FoV 1310 through which the user/operator of the vehicle 135 can view the directional pointer 1211. The FoV 1310 may be the same or similar to the FoV 310 of FIG. 3.

Additionally, the HUD may generate a route spline 1320 and smoothed route splines 1325 in a same or similar manner as the route spline 320 and the smoothed route spline 325 of FIG. 3, respectively. However, in this embodiment, the HUD generates two smoothed route splines 1325, including smoothed route splines 1325a and 1325b. In these embodiments, the two smoothed route splines 1325a-b form walls on the sides of the planned route and the pointers 1311 (which may be the same or similar as pointers 1211) are placed between these spline-walls in the FoV 1310.

Additionally, the HUD includes offset logic for generating the smoothed route splines 1325 for turns or curves/bends in the roadway such as is the case in operational scenario 1300. In these embodiments, the offset logic moves the smoothed route splines 1325a-b away from the maneuver point and/or the initial route spline 1320. In the example of FIG. 13, the offset logic adjusted the smoothed route spline 1325a to form a bump or arc around the maneuver point (indicated by the pointers 1211 in FIG. 13), and adjusted the smoothed route spline 1325b to create a more obtuse angle with respect to the inside curve in the road formed by roadside 1302b. Adjusting the smoothed splines 1325 in these ways prevents the smoothed splines 1325 from crossing the FoV 1310 thereby reducing the likelihood that the pointers 1211 will be placed at an incorrect maneuver point.

In embodiments, the offset logic may adjust the smoothed route splines 1325 based on the curvature of the road such that the offset applied to the smoothed route splines 1325 is decreased as the curve in the road decreases. Stated another way, the offset logic applies a greater offset to roads have a curve or turn with a more acute angle. Other parameters may also be adjusted to change the shape and/or size of the offset or “bump” in the smoothed route splines 1325.

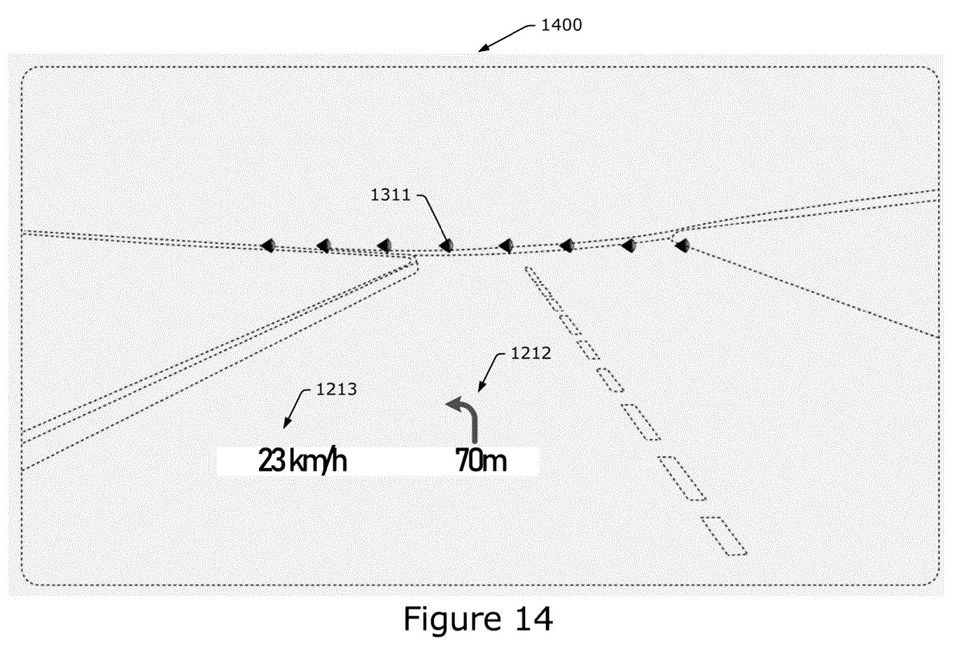

FIGS. 14-21 show various UIs that may be displayed by a vehicular HUD system/device (e.g., HUD 2400 or HUD 2500 of FIGS. 24 and 25) as the vehicle 1305 performs a left turn maneuver. In FIGS. 14-21, the broken lines represent the display screen of the HUD and real objects viewed through the display screen of the HUD, and the solid lined objects represent graphical objects or GUI elements projected onto the display screen by the HUD. The entire scene/view viewed through the display screen may represent the FoV 1310 at a certain point in time.

The various UIs 1400-2100 in FIGS. 14-21 comprise a number of graphical objects related to navigation information displayed by the HUD. The graphical objects in FIGS. 14-21 are shown in various states as the vehicle 1305 including the HUD performs one or more maneuvers. These graphical objects include the directional pointers 1311, the TBT object 1212 and the speedometer object 1213. The directional pointers 1311 may be the same or similar to directional pointers 1311 discussed previously, although the shape of directional pointers 1311 is somewhat different than the shape of directional pointers 1311 in FIGS. 14-21. The speedometer object 1213 displays a current travel speed/velocity of the vehicle 1305 and the TBT object 1212 indicates a TBT direction and/or a specific maneuver that the driver of the vehicle 1305 is to perform at the maneuver point.

In the example of FIGS. 14-21, the TBT object 1212 indicates that the driver is to make a lefthand turn, where the digit(s) underneath the TBT object 1212 indicates a current distance between the vehicle 1305 and the maneuver point. As alluded to previously, the directional pointers 1311 are placed within the UIs 1400-2100 at the maneuver point.

FIG. 14 shows a UI 1400 including a first perspective view of the directional pointers 1311 as the vehicle 1305 approaches the left turn. The directional pointers 1311 are displayed to appear floating at the maneuver point. In this example, the vehicle 1305 is currently 70 meters (m) away from the maneuver point, and the size of the directional pointers 1311 is correlated to the relative distance between the vehicle 1305 and the maneuver point (e.g., 70 m). In this example, there are eight relatively small directional pointers 1311 that have an opaque texture to improve viewability. Additionally, the opacity of the directional pointers 1311 is also based on the viewing angle of the vehicle 1305 (or HUD FoV 1310) being at (or about) 90° with respect to the directional pointers 1311.

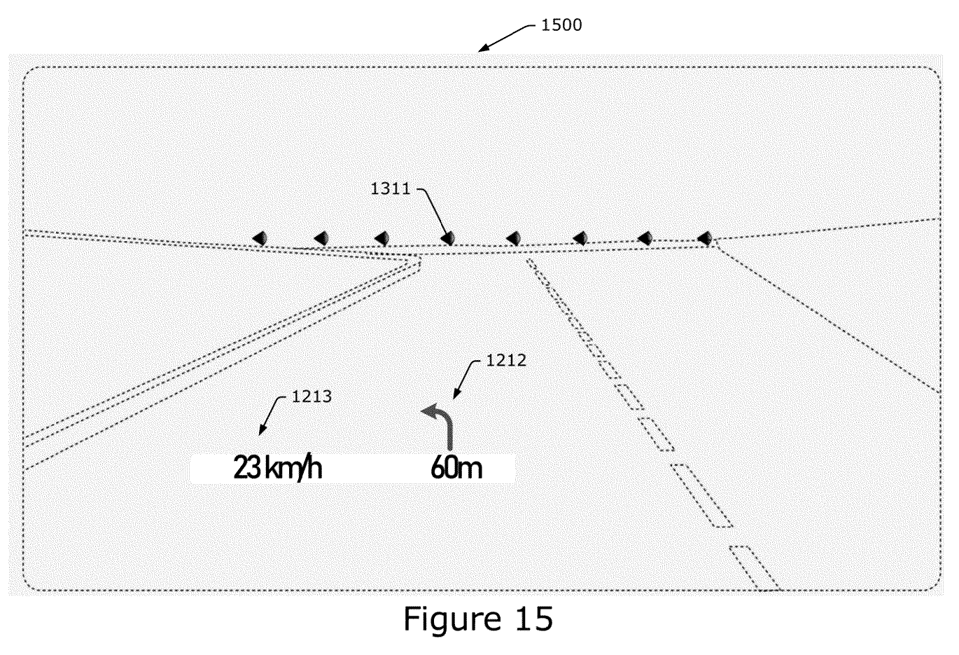

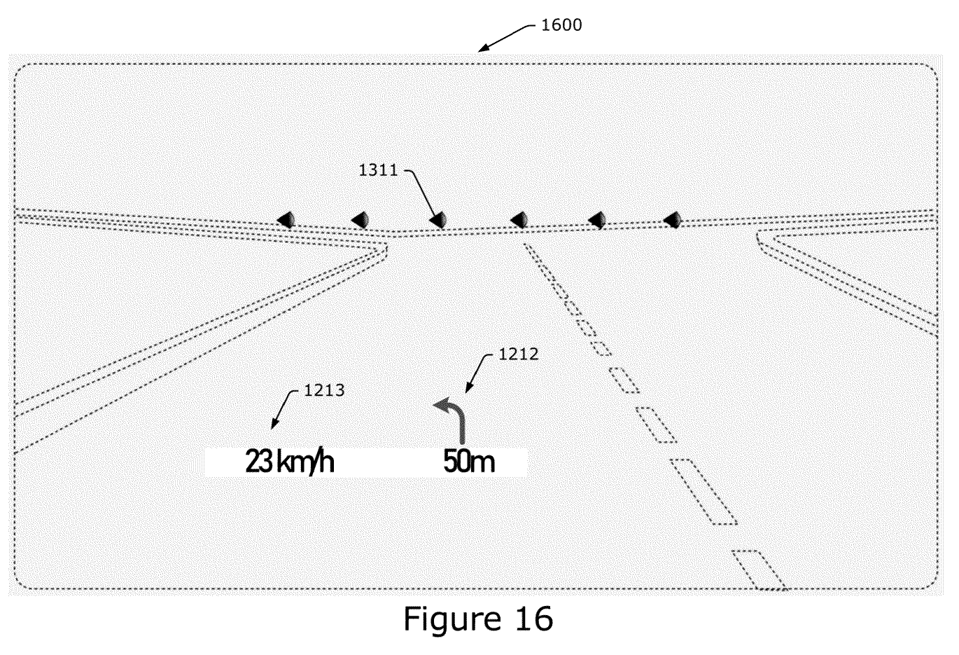

FIGS. 15 and 16 show UIs 1500 and 1600, respectively, each including perspective views of the directional pointers 1311 as the vehicle gets closer to the turn. In these examples, the directional pointers 1311 become larger in correspondence with the relative distance between the vehicle 1305 and the maneuver point (e.g., 60 m in FIG. 15 and 50 m in FIG. 16).

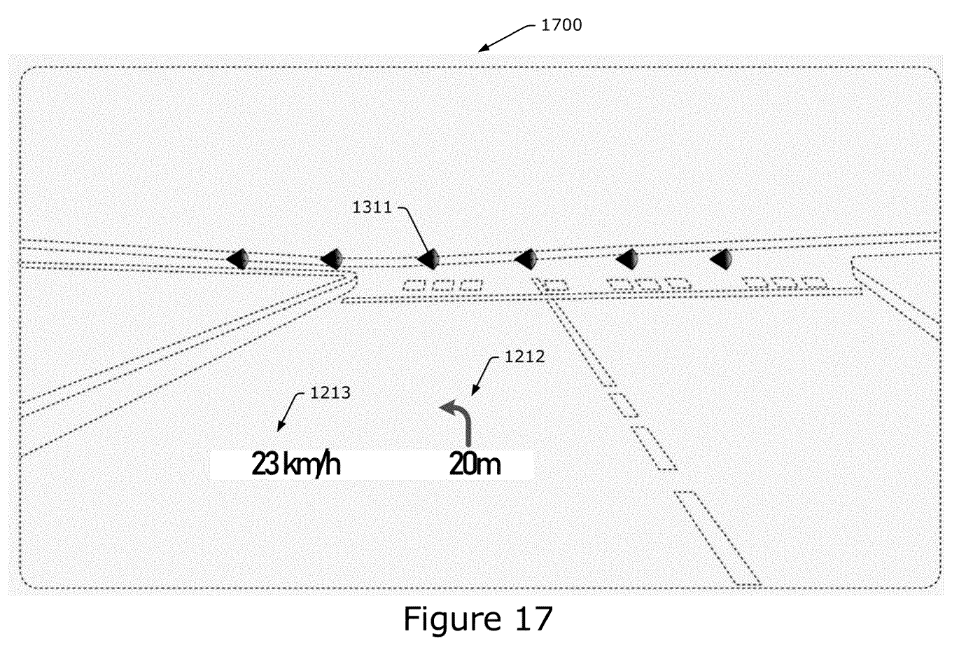

FIG. 17 shows a UI 1700 including another perspective view of directional pointers 1311 as the vehicle 1305 approaches the turn at 20 m. Similar to FIGS. 15 and 16, in this example, the directional pointers 1311 become larger in correspondence with the relative distance between the vehicle 1305 and the maneuver point. Additionally, the texture of the directional pointers 1311 is shown to begin changing at the rounded end of the directional pointers 1311, which is opposite to the pointed (tip) portion of the directional pointers 1311. This change in texture may be based on the relative distance between the vehicle 1305 and the maneuver point.

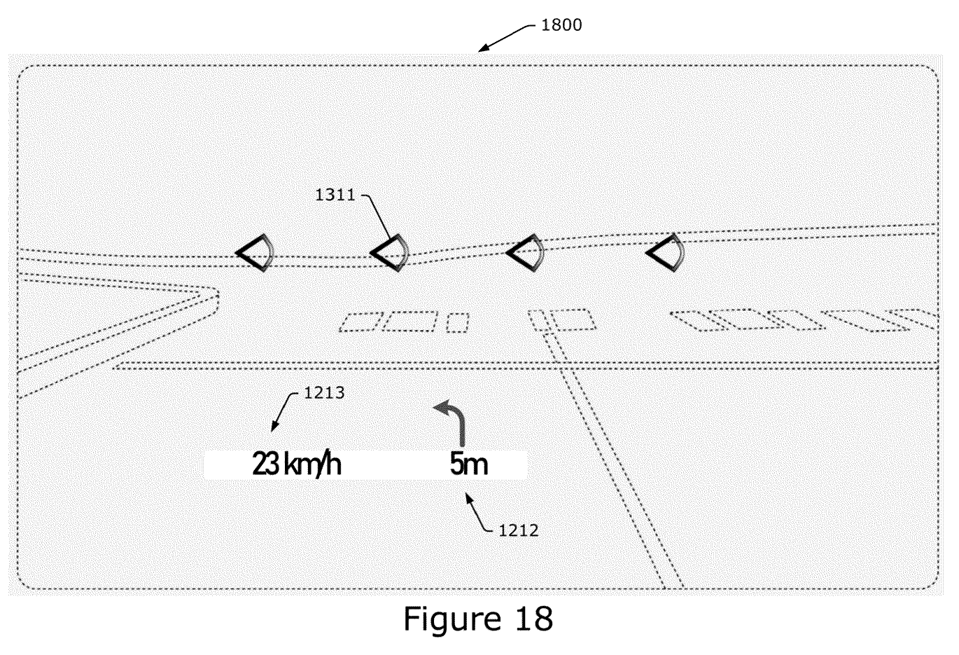

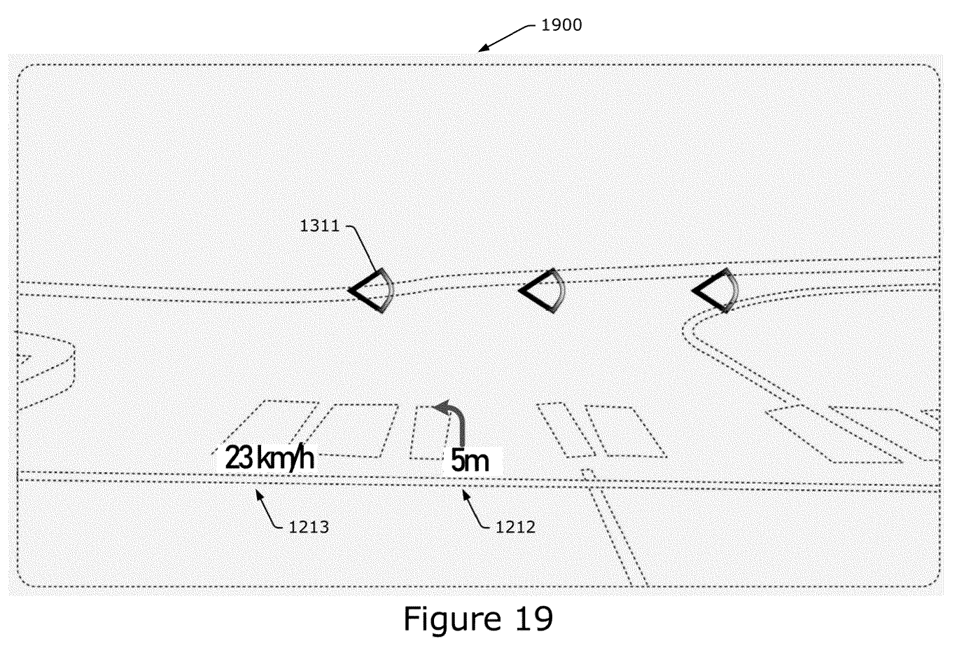

FIGS. 18 and 19 show UIs 1800 and 1900 including perspective views of the directional pointers 1311 as the vehicle 1305 is within a predetermined distance from the turn, and is about to start the maneuver. At this point, the texture of the directional pointers 1311 has changed to be mostly transparent. In this example, the texture of the directional pointers 1311 includes an outline or frame that is more opaque closer to the pointed (tip) portion of the directional pointers 1311 and becomes more faded or transparent closer to the rounded end of the directional pointers 1311.

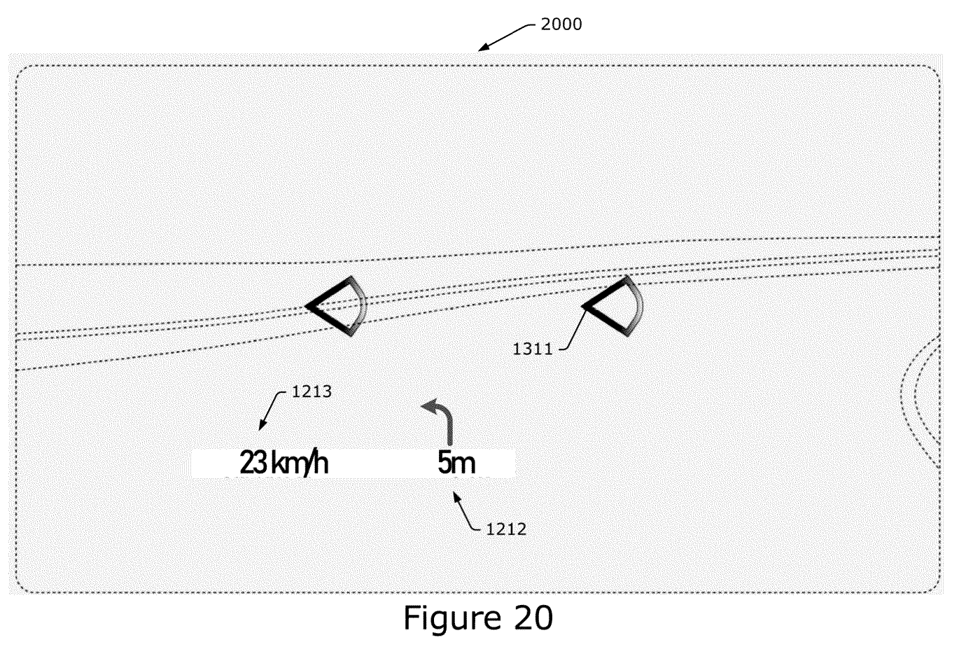

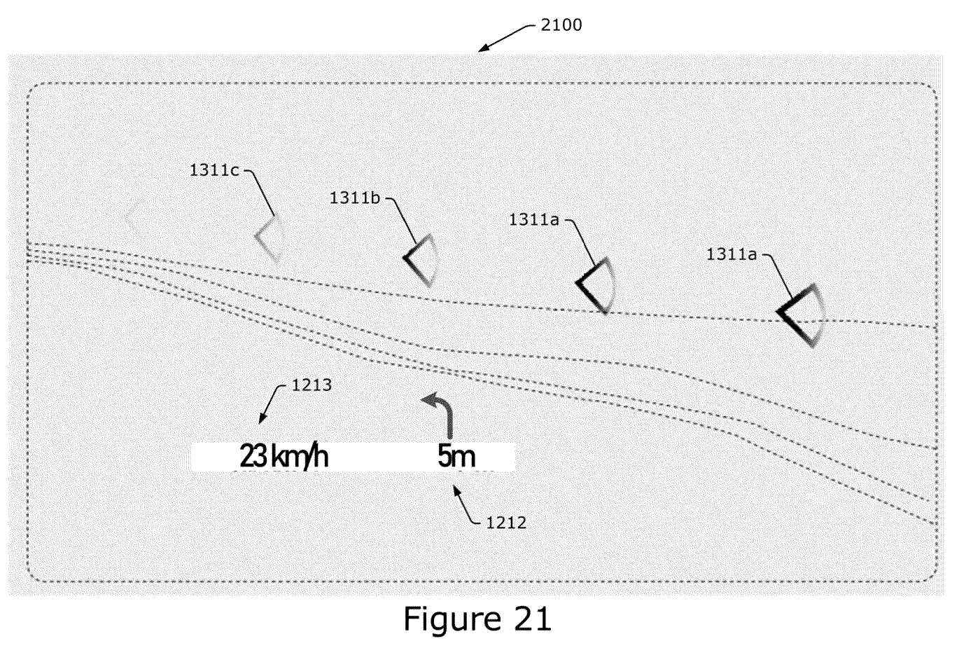

FIG. 20 shows a UI 2000 including another perspective view of directional pointers 1311 as the vehicle 1305 is making the turn. In this example, the texture of the directional pointers 1311 is beginning to become more transparent due to the changing viewing angle between the vehicle 1305 and the directional pointers 1311. FIG. 21 shows a UI 2100 including another perspective view of directional pointers 1311 as the vehicle 1305 is performing the turn maneuver. As shown by FIG. 21, the texture of individual directional pointers 1311 is more or less transparent based on the different viewing angles between the vehicle 1305 and the directional pointers 1311. For example, the outline/frame of directional pointers 1311a have more opacity than the outline/frame of directional pointer 1311b, which has more opacity than the outline/frame of directional pointer 1311c. This is because the vehicle 1305 (and thus, the viewing angle) is closer to parallel with directional pointer 1311c than directional pointer 1311b, and is closer to 90° with the directional pointers 1311a than directional pointers 1311b and 1311c.

It should be noted that the point in time or space (e.g., location) at which the HUD app/logic generates the splines 1320, 1325 and/or generates and renders the pointers 1311 may be based on specific use cases, user-configured, selected preferences, learnt user behaviors, and/or design choice, and may vary from embodiment to embodiment. In one example, the pointers 1311 may be displayed only when the vehicle 1305 reaches a predetermined distance from the maneuver point at which the pointer 111 is to point. In this example, different pointers may be displayed (see e.g., FIGS. 1-11) based on each upcoming maneuver and maneuver point. In another example, the pointer 1311 may be displayed continuously regardless of the relative distance between the vehicle 1305 and the maneuver point at which the pointer 1311 is to point. In this example, one or more pointers 1311 may be displayed between specific maneuvers such as turns, navigating around roundabouts, and the like.

Although the example embodiments of FIGS. 12-21 are described for making a turn, it should be noted that the pointers 1211, 1311 could be used for any other type of maneuver such as hard turns (e.g., 90° or more), slight or soft turns (e.g., less than 90°). U-turns, merging onto a road (e.g., highway), exiting a roadway (e.g., a highway), changing lanes, vearing in a particular direction, negotiating a roundabout, braking, accelerating, decelerating, and/or the like.

FIGS. 22-23 illustrate different pointer GUI elements that may be used as the gyroscopic pointer 111 and/or directional pointers 1211, 1311 discussed herein. Any combination of the pointers shown by FIGS. 22-23 can be used as the gyroscopic pointer 111 and/or directional pointers 1211, 1311 according to the embodiments discussed herein. Additionally, the particular pointers used can vary from HUD to HUD or vehicle to vehicle, and may be selected based on HUD or vehicle parameters and/or based on user preference. Furthermore, various textures and/or graphical effects may be applied to the pointers in FIGS. 22-23 based on, for example, the type of maneuver to be performed, various road conditions, and/or any other parameters/conditions such as those discussed herein.

### 3. Example HUD System Configurations and Arrangements

FIG. 24 illustrates an example projection system 24000 using a projector 2403 with a laser light source 2401, according to various embodiments. The projection system 2400 comprises a laser light source 2401, a projector unit 2403, an optical element 2404, a diffuser screen 2405, an imaging matrix 2406, and a screen 2407 such as a vehicle windshield. HUD combiner element, HMD combiner element, and/or the like. In the example of FIG. 24, the laser light source 2401 generates laser light 2402, which is projected by the projector unit 2403. The projector unit 2403 generates and/or projects light representative of at least one virtual image through optical element 2404, diffuser screen 2405, and onto the screen 2407 when reflected or otherwise guided by the imaging matrix 2406.

In some implementations, the optical element 2404 is or includes a collimator (e.g., a lenses set (including one or more lenses), apertures, etc.) that changes diverging light from the light source 2401 into parallel beam(s). In some implementations, the optical element 2404 may include or be a combiner (also referred to as “combiner optic” or the like), which may combine different light paths into one light path to define a palette of colors. In some implementations, the optical element 2404 may comprise scanning mirrors that copy the image pixel-by-pixel and then project the image for display. In some implementations, the optical element 2404 may be omitted. The placement of the aforementioned optical elements 2404 may vary from embodiment to embodiment, depending on the implementation used.

The light/beam(s) passing through the optical element 2404 further pass through diffuser screen 2405 and onto an imaging matrix 2406. Imaging matrix 2406, in turn, selectively distributes and/or propagates the virtual image received as light/beam(s) from projector unit 2403 via optical element 2404 and/or diffuser screen 2405 as one or more wave fronts to a screen 2407. In some examples, screen 2407 is a vehicle windshield, a holographic film 2407a placed on or adjacent to screen 2407, or a combination thereof. As examples, imaging matrix 2406 may comprise one or more mirrors, a liquid crystal display (LCD), a digital micro-mirror device (DMD), a microelectromechanical (MEMS) laser scanner, a liquid crystal on silicon (LCoS) matrix, a matte glass with a projected image, other types of imaging matrices, or any combination thereof. In some embodiments, imaging matrix 2406 may be, or may be included in, projector unit 2403 (or a PGU 2730 as discussed infra). In some implementations, the imaging matrix 2406 may be omitted.

In some implementations, the projection system 2400 comprises a transparent holographic film 2407a embedded in, or otherwise affixed to the screen 2407. The holographic film 2407a may be alternatively placed on a screen 2407 (not shown separately from system 2400) and/or placed between observer 2475 and screen 2407. In some examples, holographic film 2407a may comprise a plurality of collimators embedded in the film 2407a for collimating and/or combining light emitted from an imaging matrix 2406 with the images of real-world objects passing through the film 2407a towards observer 2475. It may be useful to develop a projector system 2400 having a long lifetime, with low power consumption and/or with a relatively noiseless operation for projector system 2400 and/or for HUDs in various types of vehicles.

The example projection system 2400 is, or is mounted in a HUD system 2500 of FIG. 25, a virtual reality (VR) and/or augmented reality (AR) display system, or the like)

FIG. 25 illustrates an example HUD system 2500 for a vehicle 2505 configured with multiple image planes, including a first image plane 2510, a second image plane 2520, and a third image plane 2530. The HUD system 2500 may correspond to the projection system 240 of FIG. 24. Additionally, the vehicle 2505 may be the same or similar as vehicle 305 of FIG. 3 and/or vehicle 1305 of FIG. 13.

The first image plane 2510 may be associated with a focal distance A, second image plane 2520 may be associated with a focal distance B, and third image plane 2520 may be associated with a focal distance that approximates infinity (∞). When vehicle 2505 is moving at relatively high speeds, such as on an uncongested highway at speeds above 40 mph, an image projection system of HUD 2500 may be configurable to display one or more computer-generated virtual graphics, e.g., images, text, or other types of imaging information, to a vehicle operator or observer 2575 on third image plane 2530. In some examples, third image plane 2530 may approximate a predetermined distance, e.g., a distance greater than twenty meters, from vehicle 2505. At relatively high speeds, observer 2575 may typically be looking down the road and scanning for objects that may be located at distances of greater than the predetermined distance of twenty meters. Accordingly, HUD system 2500 may be configurable to have the focal plane associated with the computer generated virtual graphics coincide with the relatively distant objects that are being viewed by observer 2575 (which may correspond to observer 2475 of FIG. 24).

On the other hand, when the vehicle is moving at medium range speeds, such as when the observer 2575 drives vehicle 2505 on city streets or on congested highways at speeds above 20 mph but below 40 mph, HUD system 2500 may project virtual graphics on second image plane 2520 to coincide with objects that are located at focal distance B from vehicle 2505. In some examples, focal distance B associated with second image plane 2520 may be less than twenty meters (e.g., approximately ten meters).

When vehicle 2505 is moving at relatively slow speeds, such as when observer 2575 operates vehicle 2505 around a parking lot or accident scene at speeds below 20 mph. HUD system 2500 may be configurable to project virtual graphics at first image plane 2510 to coincide with objects that are located at focal distance A from vehicle 2505. In some examples, focal distance A associated with first image plane 2510 may be less than ten meters (e.g., approximately three to five meters).

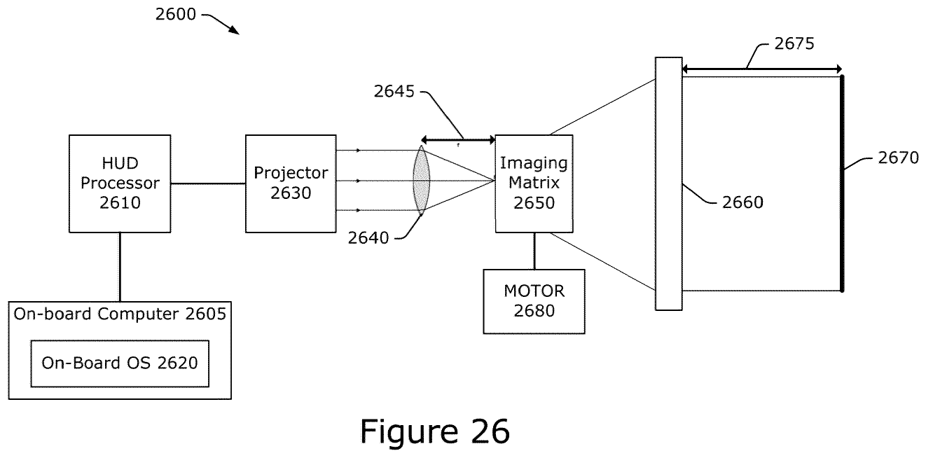

FIG. 26 illustrates an example display system 260) according to various embodiments. The display system 2600 may be, or may include aspects of the projection system 2400 of FIG. 24 and/or the HUD system 2500 of FIG. 25. In embodiments, the display system 2600 includes a HUD processor 2610 that is configurable to interface with anon-board operating system (OBOS) 2620 of an on-board computer 2605.

The on-board computer 2605 comprises one or more vehicle processors, memory of any known type (such as those discussed here), and program code and/or instructions stored in the memory. The program code and/or instructions may include code/instructions for the OBOS 2620 that interfaces with a HUD processor 2610. In an example embodiment, the HUD processor 2610 is configurable to connect to the on-board computer 2605 and/or OBOS 2620 via an on-board diagnostic (OBD) port of vehicle 2505.

HUD processor 2610 is configurable to control or otherwise operate a projection device 2630 that, in turn, is configurable to generate and/or project light representative of at least one virtual image onto an imaging matrix 2650 (e.g., which may be the same or similar to imaging matrix 2406). The HUD processor 2610 (or the on-board computer 2605) may execute, run, or otherwise operate one or more HUD apps that include instructions for generating virtual graphics based on, for example, vehicle parameters, road conditions, user parameters/commands, and/or the like. The one or more HUD apps determines virtual graphics to display on display device 2660, and the HUD processor 2610 provides indications of the virtual graphics to projection device 2630 that, in turn, projects light representative of the virtual graphic to the imaging matrix 2650.

One or more optical devices 2640 or lenses are configured to correct aberrations, filter, and/or to improve light utilization efficiencies. Optical devices 2640 may include any type of optical device (e.g., filters, diffusers, speckle diffusers, beam splitters, etc.). Imaging matrix 2650, in turn, is configured to selectively distribute and/or propagate the virtual image received as light from projection device 2630 or optical devices 2640 as one or more wave fronts to the display device 2660. As examples, the display device 2660 may comprise a vehicle windshield (e.g., screen 2407 of FIG. 24), a glass combiner or other holographic element separate from the windshield (e.g., mounted above or below the windshield, disposed on a vehicle dashboard, or the like), or a combination thereof.

In some examples, imaging matrix 2650 may comprise a holographic phase-amplitude modulator configurable to simulate an arbitrary wave front of light. In an example embodiment, imaging matrix 2650 may simulate a wave front for each of multiple image planes, each wave front representing a virtual image. Imaging matrix 2650 is configurable to implement an arbitrary number of virtual image planes with information displayed on them simultaneously and arbitrarily.

Imaging matrix 2650 may comprise a high-resolution phase modulator, such as a full high-definition modulator having any suitable resolution (e.g., 4000 or higher pixel resolution). Imaging matrix 2650 may be illuminated by coherent light received from projection device 2630 or optical devices 2640 with a predefined beam divergence. Imaging matrix 2650 may produce a digital hologram on the modulator and may project a wave front representative of the hologram onto a display device 2660 on multiple simultaneous virtual image planes 2670.

Display system 2600 is configurable or operable to generate one or more virtual graphics on image plane 2670. In some examples, image plane 2670 is associated with a focal distance 2675. Although image plane 2670 is illustrated as being located on an opposite side of display device 2660 from imaging matrix 2650, in some example embodiments, display device 2660 is configurable to reflect light associated with the wave front propagated by imaging matrix 2650 so that the resulting image is reflected back to observer 2575. While the image is reflected back from display device 2660 to observer 2575, the image plane may nevertheless appear to the observer 2575 to be located on the opposite side of the display device 2660 (e.g., on the same side of the display device as the real-world objects, outside of the vehicle).

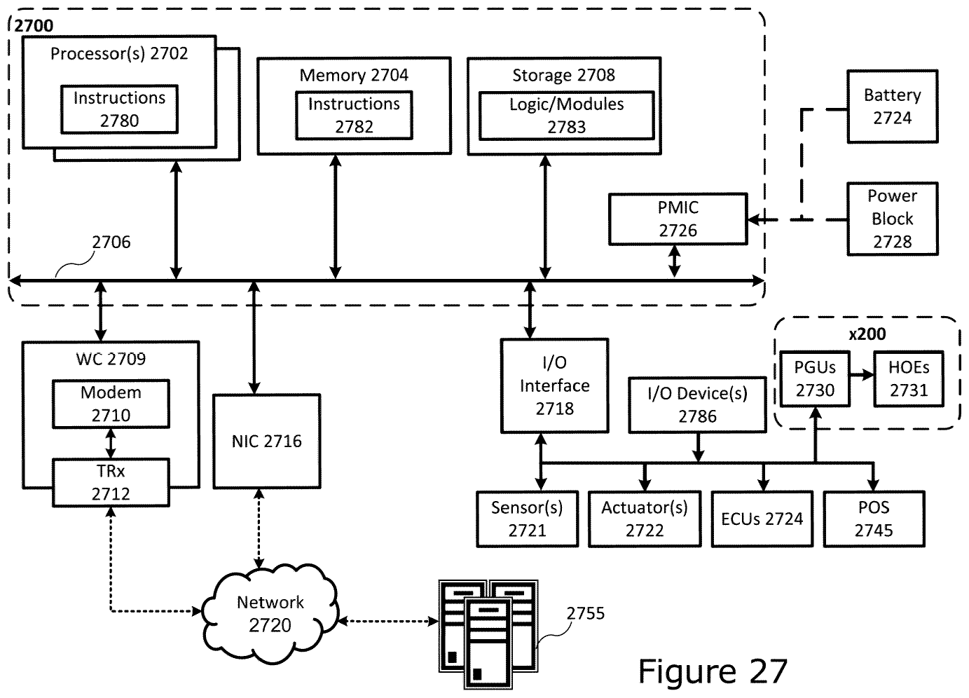

Additionally, display system 2600 may comprise a translation device or motor 2680 configurable to dynamically vary the focal distance 2675 associated with image plane 2670. In some examples, motor 2680 may move imaging matrix 2650 relative to display device 2660 in any direction (e.g., vertical or horizontal), as well as change the incline angle of imaging device 2650. In other examples, motor 2680 is configurable to move one or more optical devices 2640 relative to imaging matrix 2650. Still further, motor 2680 is configurable to vary a focal distance 2645 between the one or more optical devices 2640 and imaging matrix 2650. Motor 2680 may dynamically vary the focal distance 2675 by moving imaging matrix 2650 relative to display device 2660 or relative to optical devices 2640 or by moving optical devices 2640 relative to imaging matrix 2650. In some embodiments, the motor 2680 is one of the actuators 2722 discussed infra with respect to FIG. 27.

In embodiments, the motor 2680 may dynamically vary the focal distance 2675 according instructions, commands, or other signaling provided by one or more HUD apps. The HUD apps may cause the motor 2680 to change the focal distance 2675 based on, for example, predetermined operational parameters including vehicle parameters (e.g., speed, location, travel direction, destination, windshield location, traffic, and the like), road parameters (e.g., location or presence of real world objects, roads, and the like), vehicle observer parameters (e.g., operator location within vehicle 2505, observer eye tracking, eye location, position of system, and the like), or a combination thereof. Operational parameters may further include any input received from any of a plurality of sources including vehicle systems or settings including, for example, sensor circuitry 2721. I/O devices 2786, actuators 2722, ECUs 2724, positioning circuitry 2745, or a combination thereof as shown by FIG. 27. In addition to varying the focal distance 2675 of image plane 2670, motor 2680 is configurable to adjust the relative distance of image plane to observer 2575. The display system 2600 is compatible with a number of different types, makes, and models of vehicles which may be associated with different operator positions, including height of the operator's eyes or distance from the operator to windshield (e.g., screen 2407 shown by FIG. 24).

In an example, one of the HUD apps may be a mapping or navigation app that provides TBT indications based on TBT information obtained from a remote or local mapping service or route planning service, another app operated by the on-board computer 2605, and/or the like. Additionally, the HUD app may obtain sensor data (e.g., gyroscpe and/or acceleration data, speed data, radar/lidar and/or optical data, etc.) from one or more sensors (e.g., sensors 2721 of FIG. 27) and/or positioning data from a satellite navigation chip (e.g., positioning circuitry 2745 of FIG. 27). In this example, the HUD app obtains the TBT indications, sensor data, and/or positioning data, and generates signaling for generating graphical objects such as the gyroscopic pointers 111, the directional pointers 1211, 141, and/or any other graphical objects, such as those discussed herein, accordingly. The signaling is provided by the HUD processor 2610 to the projection device 2630, which projects light representative of the one or more graphical objects onto the imaging matrix 2650 and display device 2660. To dynamically change the graphical objects based on the various parameters, new or updated signaling may be generated and provided to the projection device 2630 and/or the motor 2680 may dynamically vary the focal distance 2675 according instructions, commands, or other signaling provided by the HUD processor 2610 operating the HUD app.

Although not shown by FIG. 26, in various embodiments, display system 2600 may include multiple projection devices 2630, optical devices 2640 imaging matrices 2650, display devices 2660, and motors 2680 that may be disposed in a multitude of arrangements.

FIG. 27 illustrates an example computing system 2700, in accordance with various embodiments. The system 2700 may include any combinations of the components as shown, which may be implemented as integrated circuits (ICs) or portions thereof, discrete electronic devices, or other modules, logic, hardware, software, firmware, middleware or a combination thereof adapted in the system 2700, or as components otherwise incorporated within a chassis of a larger system, such as a vehicle and/or HUD system. Additionally or alternatively, some or all of the components of system 2700 may be combined and implemented as a suitable System-on-Chip (SoC), System-in-Package (SiP), multi-chip package (MCP), or some other like package. The system 2700 is an embedded system or any other type of computer device discussed herein. In another example, the system 2700 may be a separate and dedicated and/or special-purpose computer device designed specifically to carry out holographic HUD solutions of the embodiments discussed herein.

The processor circuitry 2702 comprises one or more processing elements/devices configurable to perform basic arithmetical, logical, and input/output operations by carrying out and/or executing instructions. According to various embodiments, processor circuitry 2702 is configurable to perform some or all of the calculations associated with the preparation and/or generation of virtual graphics and/or other types of information that are to be projected by HUD system 2500 for display, in real time. Additionally, processor circuitry 2702 is configurable to gather information from sensor circuitry 2721 (e.g., process a video feed from a camera system or image capture devices), obtain user input from one or more I/O devices 2786, and obtain vehicle input 2750 substantially in real time. Some or all of the inputs may be received and/or transmitted via wireless communication circuitry (WC) 2709. In order to perform the aforementioned functions, the processor circuitry 2702 may execute instructions 2780, and/or may be loaded with an appropriate bit stream or logic blocks to generate virtual graphics based, at least in part, on any number of parameters, including, for example, input from sensor circuitry 2721, input from 1/O devices 2786, input from actuators 2722, input from ECUs 2724, input from positioning circuitry 2745, and/or the like. Additionally, processor circuitry 2702 may be configurable to receive audio input, or to output audio, over an audio device 2721. For example, processor circuitry 2702 may be configurable to provide signals/commands to an audio output device 2786 to provide audible instructions to accompany the displayed navigational route information or to provide audible alerts.

The processor circuitry 2702 includes circuitry such as, but not limited to one or more processor cores and one or more of cache memory, low drop-out voltage regulators (LDOs), interrupt controllers, serial interfaces such as serial peripheral interface (SPI), inter-integrated circuit (I2C) or universal programmable serial interface circuit, real time clock (RTC), timer-counters including interval and watchdog timers, general purpose input-output (I/O), memory card controllers, interconnect (IX) controllers and/or interfaces, universal serial bus (USB) interfaces, mobile industry processor interface (MIPI) interfaces. Joint Test Access Group (JTAG) test access ports, and the like. The processor circuitry 2702 may include on-chip memory circuitry or cache memory circuitry, which may include any suitable volatile and/or non-volatile memory, such as DRAM, SRAM, EPROM, EEPROM. Flash memory, solid-state memory, and/or any other type of memory device technology, such as those discussed herein.

The processor(s) of processor circuitry 2702 may be, for example, one or more application processors or central processing units (CPUs), one or more graphics processing units (GPUs), one or more reduced instruction set computing (RISC) processors, one or more Acorn RISC Machine (ARM) processors, one or more complex instruction set computing (CISC) processors, one or more DSPs, one or more microprocessor without interlocked pipeline stages (MIPS), one or more programmable logic devices (PLDs) and/or hardware accelerators) such as field-programmable gate arrays (FPGAs), structured/programmable Application Specific Integrated Circuit (ASIC), programmable SoCs (PSoCs), etc., one or more microprocessors or controllers, or any suitable combination thereof. In some embodiments, the processor circuitry 2702 may be implemented as a standalone system/device/package or as part of an existing system/device/package (e.g., an ECUT/ECM, EEMS, etc.) of the vehicle 2505. In some embodiments, the processor circuitry 2702 may include special-purpose processor/controller to operate according to the various embodiments herein.

Individual processors (or individual processor cores) of the processor circuitry 2702 may be coupled with or may include memory/storage and may be configurable to execute instructions stored in the memory/storage to enable various applications or operating systems to run on the system 2700. In these embodiments, one or more processors (or cores) of the processor circuitry 2702 may correspond to the processor 2612 of FIG. 26 and is/are configurable to operate application software (e.g., HUD app) to provide specific services to a user of the system 2700. In some embodiments, one or more processors (or cores) of the processor circuitry 2702, such as one or more GPUs or GPU cores, may correspond to the HUD processor 2610 and is/are configurable to generate and render graphics as discussed previously.

As examples, the processor circuitry 2702 may include an Intel® Architecture Core™ based processor, such as a Quark™, an Atom™, an i3, an i5, an i7, or an MCU-class processor, Pentium® processor(s), Xeon® processor(s), or another such processor available from Intel® Corporation, Santa Clara, California. However, any number other processors may be used, such as one or more of Advanced Micro Devices (AMD) Zen® Core Architecture, such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class. Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. Other examples of the processor circuitry 2702 are mentioned elsewhere in the present disclosure.

In some implementations, the processor circuitry 2702 may include a sensor hub, which acts as a coprocessor by processing data obtained from the sensor circuitry 2721. The sensor hub may include circuitry configurable to integrate data obtained from each of the sensor circuitry 2721 by performing arithmetical, logical, and input/output operations. In embodiments, the sensor hub may capable of timestamping obtained sensor data, providing sensor data to the processor circuitry 2702 in response to a query for such data, buffering sensor data, continuously streaming sensor data to the processor circuitry 2702 including independent streams for each sensor circuitry 2721, reporting sensor data based upon predefined thresholds or conditions/triggers, and/or other like data processing functions.

The memory circuitry 2704 comprises any number of memory devices arranged to provide primary storage from which the processor circuitry 2702 continuously reads instructions 2782 stored therein for execution. In some embodiments, the memory circuitry 2704 includes on-die memory or registers associated with the processor circuitry 2702. As examples, the memory circuitry 2704 may include volatile memory such as random access memory (RAM), static RAM (SRAM), dynamic RAM (DRAM), synchronous DRAM (SDRAM), etc. The memory circuitry 2704 may also include non-volatile memory (NVM) such as read-only memory (ROM), high-speed electrically erasable memory (commonly referred to as “flash memory”), and non-volatile RAM such as phase change memory, resistive memory such as magnetoresistive random access memory (MRAM), etc.

In some implementations, the processor circuitry 2702 and memory circuitry 2704 (and/or storage device 2708) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry 2702 to implement various logic functions. The memory cells may include any combination of various levels of memory/storage including, but not limited to, EPROM, EEPROM, flash memory, SRAM, anti-fuses, etc. The memory circuitry 2704 may also comprise persistent storage devices, which may be temporal and/or persistent storage of any type, including, but not limited to, non-volatile memory, optical, magnetic, and/or solid state mass storage, and so forth.

Storage circuitry 2708 is arranged to provide (with shared or respective controllers) persistent storage of information such as data, applications, operating systems, and so forth. As examples, the storage circuitry 2708 may be implemented as hard disk drive (HDD), a micro HDD, a solid-state disk drive (SSDD), flash memory, flash memory cards (e.g., SD cards, microSD cards, xD picture cards, and the like), USB flash drives, resistance change memories, phase change memories, holographic memories, or chemical memories, and the like. In an example, the storage circuitry 2708 may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. As shown, the storage circuitry 2708 is included in the system 2700; however, in other embodiments, storage circuitry 2708 may be implemented as one or more separate devices that are mounted in vehicle 2505 separate from the other elements of system 2700.

The storage circuitry 2708 is configurable to store computational logic 2783 (or “modules 2783”) in the form of software, firmware, microcode, or hardware-level instructions to implement the techniques described herein. The computational logic 2783 may be employed to store working copies and/or permanent copies of programming instructions for the operation of various components of system 2700 (e.g., drivers, libraries, application programming interfaces (APIs), etc.), an OS of system 2700, one or more applications, and/or for carrying out the embodiments discussed herein. According to various embodiments, the computational logic 2783 may include one or more HUD apps discussed previously. The permanent copy of the programming instructions may be placed into persistent storage devices of storage circuitry 2708 in the factory or in the field through, for example, a distribution medium (not shown), through a communication interface (e.g., from a distribution server (not shown)), or over-the-air (OTA). The computational logic 2783 may be stored or loaded into memory circuitry 2704 as instructions 2782, which are then accessed for execution by the processor circuitry 2702 to carry out the functions described herein. The instructions 2782 direct the processor circuitry 2702 to perform a specific sequence or flow of actions, for example, as described with respect to the flowchart(s) and block diagram(s) of operations and functionality depicted herein. The modules/logic 2783 and/or instructions 2780 may be implemented by assembler instructions supported by processor circuitry 2702 or high-level languages that may be compiled into instructions 2780 to be executed by the processor circuitry 2702.

The computer program code for carrying out operations of the present disclosure (e.g., computational logic 2783, instructions 2782, 2780, etc.) may be written in any combination of one or more programming languages, including an object oriented programming language such as Python, Ruby, Scala, Smalltalk, Java™, C++, C #, or the like; a procedural programming languages, such as the “C” programming language, the Go (or “Golang”) programming language, or the like; a scripting language such as JavaScript, Server-Side JavaScript (SSJS), PHP, Pearl, Python, Ruby or Ruby on Rails. Accelerated Mobile Pages Script (AMPscript), VBScript, and/or the like; a markup language such as HTML, XML, wiki markup or Wikitext, Wireless Markup Language (WML), etc.; a data interchange format/definition such as Java Script Object Notion (JSON), Apache® MessagePack™, etc.; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), etc.; or some other suitable programming languages including proprietary programming languages and/or development tools, or any other languages or tools as discussed herein. The computer program code for carrying out operations of the present disclosure may also be written in any combination of the programming languages discussed herein. The program code may execute entirely on the system 2700, partly on the system 2700 as a stand-alone software package, partly on the system 2700 and partly on a remote computer, or entirely on the remote computer. In the latter scenario, the remote computer may be connected to the system 2700 through any type of network (e.g., network 2720).

The OS of system 2700 manages computer hardware and software resources, and provides common services for various applications (e.g., HUD apps or the like). The OS of system 2700 may be or include the OBOS 2620 discussed previously. The OS may include one or more drivers or APIs that operate to control particular devices that are embedded in the system 2700, attached to the system 2700, or otherwise communicatively coupled with the system 2700. The drivers may include individual drivers allowing other components of the system 2700 to interact or control various I/O devices that may be present within, or connected to, the system 2700. For example, the drivers may include a display driver (or HUD system driver) to control and allow access to the HUD system 2500, a touchscreen driver to control and allow access to a touchscreen interface of the system 2700, sensor drivers to obtain sensor readings of sensor circuitry 2721 and control and allow access to sensor circuitry 2721, actuator drivers to obtain actuator positions of the actuators 2722 and/or control and allow access to the actuators 2722, ECU drivers to obtain control system information from one or more of the ECUs 2724, audio drivers to control and allow access to one or more audio devices. The OSs may also include one or more libraries, drivers, APIs, firmware, middleware, software glue, etc., which provide program code and/or software components for one or more applications to obtain and use the data from other applications operated by the system 2700.

In some embodiments, the OS may be a general purpose OS, while in other embodiments, the OS is specifically written for and tailored to the system 2700. For example, the OS may be Unix or a Unix-like OS such as Linux e.g., provided by Red Hat Enterprise, Windows 10™ provided by Microsoft Corp.®, macOS provided by Apple Inc.®, or the like. In another example, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like. In another example, the OS may be an embedded OS or a real-time OS (RTOS), such as Windows Embedded Automotive provided by Microsoft Corp.®, Windows 10 For IoT® provided by Microsoft Corp.®, Apache Mynewt provided by the Apache Software Foundation®, Micro-Controller Operating Systems (“MicroC/OS” or “μC/OS”) provided by Micrium®, Inc., FreeRTOS, VxWorks® provided by Wind River Systems, Inc.®, PikeOS provided by Sysgo AG®, Android Things® provided by Google Inc.®, QNX® RTOS provided by BlackBerry Ltd., or any other suitable embedded OS or RTOS, such as those discussed herein. In another example, the OS may be a robotics middleware framework, such as Robot Operating System (ROS), Robotics Technology (RT)-middleware provided by Object Management Group®, Yet Another Robot Platform (YARP), and/or the like.

In embodiments where the processor circuitry 2702 and memory circuitry 2704 includes hardware accelerators in addition to or alternative to processor cores, the hardware accelerators may be pre-configured (e.g., with appropriate bit streams, logic blocks/fabric, etc.) with the logic to perform some functions of the embodiments herein (in lieu of employment of programming instructions to be executed by the processor core(s)).

The components of system 2700 and/or vehicle 2505 communicate with one another over an interconnect (IX) 2706. In various embodiments. IX 2706 is a controller area network (CAN) bus system, a Time-Trigger Protocol (TTP) system, or a FlexRay system, which may allow various devices (e.g., ECUs 2724, sensor circuitry 2721, actuators 2722, etc.) to communicate with one another using messages or frames. Additionally or alternatively, the IX 2706 may include any number of other IX technologies, such as a Local Interconnect Network (LIN), industry standard architecture (ISA), extended ISA (EISA), inter-integrated circuit (I2C), a serial peripheral interface (SPI), point-to-point interfaces, power management bus (PMBus), peripheral component interconnect (PCI), PCI express (PCIe), Ultra Path Interface (UPI), Accelerator Link (IAL), Common Application Programming Interface (CAPI), QuickPath Interconnect (QPI), Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 2706 may be a proprietary bus, for example, used in a SoC based system.

The WC 2709 comprises a hardware element, or collection of hardware elements, used to communicate over one or more networks (e.g., network 2720) and/or with other devices. The WC 2709 includes modem 2710 and transceiver circuitry (TRx) 2712. The modem 2710 includes one or more processing devices (e.g., baseband processors) to carry out various protocol and radio control functions. Modem 2710 interfaces with application circuitry of system 2700 (e.g., a combination of processor circuitry 2702 and CRM 2760) for generation and processing of baseband signals and for controlling operations of the TRx 2712. The modem 2710 handles various radio control functions that enable communication with one or more radio networks (e.g., network 2720) via the TRx 2712 according to one or more wireless communication protocols, such as those discussed herein. The modem 2710 may include circuitry such as, but not limited to, one or more single-core or multi-core processors (e.g., one or more baseband processors) or control logic to process baseband signals received from a receive signal path of the TRx 2712, and to generate baseband signals to be provided to the TRx 2712 via a transmit signal path. In various embodiments, the modem 2710 may implement a real-time OS (RTOS) to manage resources of the modem 2710, schedule tasks, etc.

The WC 2709 also includes TRx 2712 to enable communication with wireless networks (e.g., network 2720) using modulated electromagnetic radiation through a non-solid medium. TRx 2712 includes a receive signal path, which comprises circuitry to convert analog RF signals (e.g., an existing or received modulated waveform) into digital baseband signals to be provided to the modem 2710. The TRx 2712 also includes a transmit signal path, which comprises circuitry configurable to convert digital baseband signals provided by the modem 2710 to be converted into analog RF signals (e.g., modulated waveform) that will be amplified and transmitted via an antenna array including one or more antenna elements (not shown). The antenna array is coupled with the TRx 2712 using metal transmission lines or the like. The antenna array may be a one or more microstrip antennas or printed antennas that are fabricated on the surface of one or more printed circuit boards; a patch antenna array formed as a patch of metal foil in a variety of shapes; a glass-mounted antenna array or “on-glass” antennas; or some other known antenna or antenna elements.

The TRx 2712 may include one or more radios that are compatible with, and/or may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a 3GPP radio communication technology such as Universal Mobile Telecommunications System (UMTS), Freedom of Multimedia Access (FOMA), Code Division Multiple Access 2000 (CDM2000), Cellular Digital Packet Data (CDPD), Mobitex, Circuit Switched Data (CSD), High-Speed Circuit-Switched Data (HSCSD), UMTS Wideband Code Division Multiple Access, High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), Time Division-Code Division Multiple Access (TD-CDMA), Time Division-Synchronous Code Division Multiple Access (TD-CDMA), Long Term Evolution (LTE), LTE-Advanced (LTE-A), LTE Extra, LTE-A Pro, LTE Licensed-Assisted Access (LAA), MuLTEfire. UMTS Terrestrial Radio Access (UTRA), Evolved UMTS Terrestrial Radio Access (E-UTRA), Fifth Generation (5G) or New Radio (NR), 3GPP device-to-device (D2D) or Proximity Services (ProSe), 3GPP cellular vehicle-to-everything (V2X), Evolution-Data Optimized or Evolution-Data Only (EV-DO), Advanced Mobile Phone System (AMPS). Total Access Communication System/Extended Total Access Communication System (TACS/ETACS), Digital AMPS (D-AMPS), Push-to-talk (PTT), Mobile Telephone System (MTS), Improved Mobile Telephone System (IMTS), Advanced Mobile Telephone System (AMTS), Offentlig Landmobil Telefoni (OLT) which is Norwegian for Public Land Mobile Telephony, Mobiltelefonisystem D (MTD) which is Swedish for Mobile telephony system D, Public Automated Land Mobile (Autotel/PALM), Autoradiopuhelin (ARP) which is Finnish for “car radio phone”, Nordic Mobile Telephony (NMT), Nippon Telegraph and Telephone (NTT), High capacity (Hicap) version of NTT, Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA) also referred to as also referred to as 3GPP Generic Access Network (GAN), Bluetooth. Bluetooth Low Energy (BLE), IEEE 802.15.4 based protocols (e.g., IPv6 over Low power Wireless Personal Area Networks (6LoWPAN), WirelessHART, MiWi, Thread, 1600.11a, etc.) WiFi-direct, ANT/ANT+, ZigBee, Z-Wave, Universal Plug and Play (UPnP), Low-Power Wide-Area-Network (LPWAN), LoRaWANT™ (Long Range Wide Area Network), Sigfox, Wireless Gigabit Alliance (WiGig) standard, mmWave standards in general (wireless systems operating at 10-300 GHz and above such as WiGig, IEEE 802.1 lad, IEEE 802.11 ay, etc.), technologies operating above 300 GHz and THz bands, (3GPP/LTE based or IEEE 802.11p and other), Dedicated Short Range Communications (DSRC) communication systems such as Intelligent-Transport-Systems and others, the European ITS-G5 system (i.e. the European flavor of IEEE 802.11p based DSRC, including ITS-GSA (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), etc. In addition to the aforementioned standards, any number of satellite uplink technologies may be used for the TRx 2712 including, for example, radios compliant with standards issued by the International Telecommunication Union (ITU), or the European Telecommunications Standards Institute (ETSI), among others, both existing and not yet formulated.

Network interface circuitry/controller (NIC) 2716 may be included to provide wired communication to the network 2720 or to other devices using a standard network interface protocol. In most cases, the NIC 2716 may be used to transfer data over a network (e.g., network XA20) via a wired connection while the vehicle is stationary (e.g., in a garage, testing facility, or the like). The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 2700 via NIC 2716 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 2716 may include one or more dedicated processors and/or FPGAs to communicate using one or more of the aforementioned network interface protocols. In some implementations, the NIC 2716 may include multiple controllers to provide connectivity to other networks using the same or different protocols. For example, the system 2700 may include a first NIC 2716 providing communications to the network 2720 over Ethernet and a second NIC 2716 providing communications to other devices over another type of network. In some implementations, the NIC 2716 may be a high-speed serial interface (HSSI) NIC to connect the system 2700 to a routing or switching device.

Network 2750 comprises computers, network connections among various computers (e.g., between the system 2700 and remote system 2755), and software routines to enable communication between the computers over respective network connections. In this regard, the network 2750 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 2750 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 2750 may require that the computers execute software routines which enable, for example, the seven layers of the OSI model of computer networking or equivalent in a wireless (or cellular) phone network.

The network 2750 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 2750 may be associated with network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), an enterprise network, a non-TCP/IP based network, any LAN or WAN or the like.

The system 2700 includes communication circuitry comprising physical hardware devices and/or software components capable of providing and/or accessing content and/or services to/from the remote system 2755. The term “communication circuitry” may refer to any combination of the WC 2709, the NIC 2716, and/or interface circuitry 2718. The system 2700 and/or the remote system 2755 can be implemented as any suitable computing system or other data processing apparatus usable to access and/or provide content and/or services from/to one another. As examples, the system 2700 and/or the remote system 2755 may comprise desktop computers, a work stations, laptop computers, mobile cellular phones (e.g., “smartphones”), tablet computers, portable media players, wearable computing devices, server computer systems, an aggregation of computing resources (e.g., in a cloud-based environment), or some other computing devices capable of interfacing directly or indirectly with network 2750 or other network. The system 2700 communicates with remote systems 2755, and vice versa, to obtain/serve content/services using, for example, Hypertext Transfer Protocol (HTTP) over Transmission Control Protocol (TCP)/Internet Protocol (IP), or one or more other common Internet protocols such as File Transfer Protocol (FTP); Session Initiation Protocol (SIP) with Session Description Protocol (SDP), Real-time Transport Protocol (RTP), or Real-time Streaming Protocol (RTSP); Secure Shell (SSH), Extensible Messaging and Presence Protocol (XMPP); WebSocket; and/or some other communication protocol, such as those discussed herein.

According to various embodiments, the one or more apps (e.g., HUD apps) operated by processor circuitry 2702 may be a navigation app (also referred to as a “mapping app”, a “TBT app”, a “trip planner”, “route planner”, or the like) comprising a front end UI to gather travel requirements from the user (e.g., observer 2475) and present proposed routes or journeys to the user. The navigation app may interface with a back end journey planning engine (also referred to as a a “trip planning engine”, “route planning engine”, and/or the like) that analyzes the user inputs and generates the proposed routes/journeys according to the user's optimization criteria (e.g., fastest route, specific roadways (e.g., highways or no highways), cheapest (e.g., no toll roads), etc.). Each of the proposed routes/journeys may include an entire route, including various waypoints or locations, legs, and a list of maneuvers.

The user inputs may be provided to the journey planning engine via suitable request messages (e.g., HTTP requests). Examples of the user inputs include an origin point (e.g., a place identifier, address, geolocation data and/or GNSS coordinates, or textual latitude/longitude value from which to calculate the route directions); a destination point (e.g., a place identifier, address, geolocation data and/or GNSS coordinates, or textual latitude/longitude value to which to calculate the route directions); transportation mode (e.g., driving, walking, public transit, etc.); one or more waypoints (e.g., a list or array of intermediate locations to include along the route between the origin and destination points as pass through or stopover locations); arrival time; departure time; routes or road types to avoid; and/or the like.

In some implementations, the journey planning engine may determine optimal routes by solving a shortest path problem (e.g., as Dijkstra's, A*, Floyd-Warshall, Johnson's algorithm, etc.), which examines how to identify the path that best meets some criteria (shortest, cheapest, fastest, etc.) between two points in a large network. In graphy theory, the shortest path problem involves finding a path between two or more nodes in a graph data structure such that the sum of the weights of its constituent edges is minimized. Here, a “graph” is a set of edges connected by nodes used for building a route, where an edge is a line connected between nodes and the path is a sequence of edges forming a route. A route is represented as a sequence of edges and maneuvers forming the best travel path between two or more locations given an available road network, costs, influence factors, and other inputs.

The journey planning engine may be either local (e.g., stored by the memory circuitry 2704 and/or storage circuitry 2708 and operated by the processor circuitry 2702) or remote (e.g., operated by the remote system 2755 and accessed via the communication circuitry) and may have either a monolithic (all the data in a single search space) or a distributed architecture (the data for different regions split among different engines, each with their own search space). Examples of the journey planning engine include the Open Source Routing Machine (OSRM). GraphHopper, Google Maps® route planner provided by Google®, LLC, Apple Maps® provided by Apple Inc., Valhalla Open Source Routing Engine. and/or the like.

The journey planning engine provides a suitable response (e.g., in JSON, XML, or other like format) indicating the optimal routes. As examples, the response may include or indicate a list or array of geocoded waypoints (e.g., data about the geocoding of the origin, destination, and waypoints); a list or array of routes from the origin to the destination points; a list or array of available travel modes for each of the routes; and/or metadata such as status codes and the like.

The UI of the navigation app may integrate interactive maps and location data (e.g., GNSS data provided by positioning circuitry 2745) to provide a visualization of the trip or to simplify the interaction with the user. The UI may provide turn-by-turn (TBT) navigation information where directions for a selected route are continually presented to the user in the form of spoken and/or visual instructions. The UI may include graphical elements, such as the gyroscopic pointer 111 and/or the directional pointers 1211, 1311, that may be displayed as discussed herein according to the TBT navigation information of the selected route provided by the journey planning engine. The UI may also include (and output) a narration to go along with the visual UX/UI. In the context of turn-by-turn navigation, the term “narration” refers to textual and/or audio guidance describing a maneuver to be performed, distance to travel, expected time, and/or other like route-related information and criteria.

The input/output (I/O) interface 2718 is configurable to connect or coupled the system 2700 with external devices or subsystems. The external interface 2718 may include any suitable interface controllers and connectors to couple the system 2700 with the external components/devices, such as an external expansion bus (e.g., Universal Serial Bus (USB), FireWire, PCIe, Thunderbolt, etc.), used to connect system 2700 with external components/devices, such as sensor circuitry 2721, actuators 2722, electronic control units (ECUs) 2724, positioning system 2745. V/O device(s) 2786, and picture generation units (PGUs) 2730. In some cases, the I/O interface circuitry 2718 may be used to transfer data between the system 2700 and another computer device (e.g., a laptop, a smartphone, or some other user device) via a wired connection. I/O interface circuitry 2718 may include any suitable interface controllers and connectors to interconnect one or more of the processor circuitry 2702, memory circuitry 2704, storage circuitry 2708, WC 2709, and the other components of system 2700. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., IX 2706), ports, slots, jumpers, interconnect modules, receptacles, modular connectors, etc. The I/O interface circuitry 2718 may also include peripheral component interfaces including, but are not limited to, non-volatile memory ports, USB pons, audio jacks, power supply interfaces, on-board diagnostic (OBD) ports, etc.

The sensor circuitry 2721 includes devices, modules, or subsystems whose purpose is to detect events or changes in its environment and send the information (sensor data) about the detected events to some other a device, module, subsystem, etc. Examples of such sensors 2721 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

Some of the sensor circuitry 2721 may be sensors used for various vehicle control systems, and may include, inter alia, exhaust sensors including exhaust oxygen sensors to obtain oxygen data and manifold absolute pressure (MAP) sensors to obtain manifold pressure data; mass air flow (MAF) sensors to obtain intake air flow data; intake air temperature (IAT) sensors to obtain IAT data; ambient air temperature (AAT) sensors to obtain AAT data; ambient air pressure (AAP) sensors to obtain AAP data; catalytic converter sensors including catalytic converter temperature (CCT) to obtain CCT data and catalytic convener oxygen (CCO) sensors to obtain CCO data; vehicle speed sensors (VSS) to obtain VSS data; exhaust gas recirculation (EGR) sensors including EGR pressure sensors to obtain ERG pressure data and EGR position sensors to obtain position/orientation data of an EGR valve pintle; Throttle Position Sensor (TPS) to obtain throttle position/orientation/angle data; a crank/cam position sensors to obtain crank/cam/piston position/orientation/angle data; coolant temperature sensors; and/or other like sensors embedded in vehicles 2505. The sensor circuitry 2721 may include other sensors such as an accelerator pedal position sensor (APP), accelerometers, magnetometers, level sensors, flow/fluid sensors, barometric pressure sensors, and the like.

The positioning circuitry 2745 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS). France's Doppler Orbitography and Radio-positioning Integrated by Satellite (DORIS), etc.), or the like. The positioning circuitry 2745 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 2745 may include a Micro-Technology for Positioning. Navigation, and Timing (Micro-PNT) IC that uses a master timing clock to perform position tracking/estimation without GNSS assistance. The positioning circuitry 2745 may also be part of, or interact with, the WC 2709 to communicate with the nodes and components of the positioning network. The positioning circuitry 2745 may also provide position data and/or time data to the application circuitry, which may use the data to synchronize operations with various infrastructure (e.g., radio base stations), for turn-by-turn navigation, or the like. Additionally or alternatively, the positioning circuitry 2745 may be incorporated in, or work in conjunction with the communication circuitry to determine the position or location of the vehicle 2505 by, for example, implementing the LTE Positioning Protocol (LPP), Wi-Fi positioning system (WiPS or WPS) methods, triangulation, signal strength calculations, and/or some other suitable localization technique(s).

In some embodiments, sensor circuitry 2721 may be used to corroborate and/or reline information provided by positioning circuitry 2745. In a first example, input from a camera 2721 may be used by the processor circuitry 2702 (or a HUD app operated by the processor circuitry 2702) to measure the relative movement of an object/image and to calculate the vehicle movement speed and turn speed to calibrate or improve the precision of a position sensor 2721/2745. In a second example, input from a barometer may be used in conjunction with the positioning circuitry 2745 (or a HUD app operated by the processor circuitry 2702) to more accurately determine the relative altitude of the vehicle 2505, and determine the position of the vehicle 2505 relative to a mapped coordinate system. In a third example, images or video captured by a camera 2721 or image aperture device 2721 may be used in conjunction with the positioning circuitry 2745 (or a HUD app operated by the processor circuitry 2702) to more accurately determine the relative distance between the vehicle 2505 and particular feature or landmark associated with the mapped coordinate system, such as a turn or a destination. In a fourth example, input from an inertial sensor 2721 may be used by the processor circuitry 2702 (or a HUD app operated by the processor circuitry 2702) to calculate and/or determine vehicle speed, turn speed, and/or position of the vehicle 2505. In a fourth example, processor circuitry 2702 (or a HUD app operated by the processor circuitry 2702) may be configurable to locate and/or identify a vehicle operator by a user recognition device/system, which may comprise a camera 2721 or tracking device 2721 configurable to identify the operator and/or to locate the operator's relative position and/or height relative to a display device (e.g., an HOE 2731 discussed infra). Based on information received from user input and/or user recognition device/system, processor circuitry 2702 (or a HUD app operated by the processor circuitry 2702) may be configurable to initialize, customize, adjust, calibrate, or otherwise modify the functionality of system 2700 to accommodate a particular user.

Individual ECUs 2724 may be embedded systems or other like computer devices that control a corresponding system of the vehicle 2505. In embodiments, individual ECUs 2724 may each have the same or similar components as the system 2700, such as a microcontroller or other like processor device, memory device(s), communications interfaces, and the like. In embodiments, the ECUs 2724 may include, inter alia, a Drivetrain Control Unit (DCU), an Engine Control Unit (ECU), an Engine Control Module (ECM), EEMS, a Powertrain Control Module (PCM), a Transmission Control Module (TCM), a Brake Control Module (BCM) including an anti-lock brake system (ABS) module and/or an electronic stability control (ESC) system, a Central Control Module (CCM), a Central Timing Module (CTM), a General Electronic Module (GEM), a Body Control Module (BCM), a Suspension Control Module (SCM), a Door Control Unit (DCU), a Speed Control Unit (SCU), a Human-Machine Interface (HMI) unit, a Telematic Control Unit (TTU), a Battery Management System (which may be the same or similar as battery monitor 2726) and/or any other entity or node in a vehicle system. In some embodiments, the one or more of the ECUs 2724 and/or system 2700 may be part of or included in a Portable Emissions Measurement Systems (PEMS).

The actuators 2722 are devices that allow system 2700 to change a state, position, orientation, move, and/or control a mechanism or system in the vehicle 2505. The actuators 2722 comprise electrical and/or mechanical devices for moving or controlling a mechanism or system, and converts energy (e.g., electric current or moving air and/or liquid) into some kind of motion. The actuators 2722 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2722 may include one or more electromechanical devices such as pneumatic actuators, hydraulic actuators, electromechanical switches including electromechanical relays (EMRs), motors (e.g., linear motors, DC motors, brushless motors, stepper motors, servomechanisms, ultrasonic piezo motor with optional position feedback, screw-type motors, etc.), mechanical gears, magnetic switches, valve actuators, fuel injectors, ignition coils, wheels, thrusters, propellers, claws, clamps, hooks, an audible sound generator, and/or other like electromechanical components. As examples, the translation device or motor 2680 discussed previously may be among the one or more of the actuators 2722. The system 2700 may be configurable to operate one or more actuators 2722 based on one or more captured events and/or instructions or control signals received from various ECUs 2724 or system 2700. In embodiments, the system 2700 may transmit instructions to various actuators 2722 (or controllers that control one or more actuators 2722) to change the state of the actuators 2722 or otherwise control operation of the actuators 2722.

In embodiments, system 2700 and/or ECUs 2724 are configurable to operate one or more actuators 2722 by transmitting/sending instructions or control signals to one or more actuators 2722 based on detected events. Individual ECUs 2724 may be capable of reading or otherwise obtaining sensor data from the sensor circuitry 2721, processing the sensor data to generate control system data, and providing the control system data to the system 2700 for processing. The control system information may be a type of state information discussed previously. For example, an ECU 2724 may provide engine revolutions per minute (RPM) of an engine of the vehicle 2505, fuel injector activation timing data of one or more cylinders and/or one or more injectors of the engine, ignition spark timing data of the one or more cylinders (e.g., an indication of spark events relative to crank angle of the one or more cylinders), transmission gear ratio data and/or transmission state data (which may be supplied to the ECU 2724 by the TCU), real-time calculated engine load values from the ECM, etc.; a TCU may provide transmission gear ratio data, transmission state data, etc.; and the like.

The I/O devices 2786 may be present within, or connected to, the system 2700. The L/O devices 2786 include input devices and output devices including one or more user interfaces designed to enable user interaction with the system 2700 and/or peripheral component interaction with the system 2700 via peripheral component interfaces. The input devices include any physical or virtual means for accepting an input including, inter alia, one or more physical or virtual buttons (e.g., a reset button), a physical keyboard, keypad, mouse, touchpad, touchscreen, microphones, scanner, headset, and/or the like. It should be noted that user input may comprise voice commands, control input (e.g., via buttons, knobs, switches, etc.), an interface with a smartphone, or any combination thereof.

The output devices are used to show or convey information, such as sensor readings, actuator position(s), or other like information. Data and/or graphics may be displayed on one or more UI components of the output devices. The output devices may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 2700. The output devices may also include speakers or other audio emitting devices, printer(s), and/or the like. In some embodiments, the output devices include the HUD system 2500 in addition to the aforementioned output devices. In some embodiments, the sensor circuitry 2721 may be used as an input device (e.g., an image capture device, motion capture device, or the like) and one or more actuators 2722 may be used as an output device (e.g., an actuator to provide haptic feedback or the like). In another example, near-field communication (NFC) circuitry comprising an NFC controller coupled with an antenna element and a processing device may be included as an input device to read electronic tags and/or connect with another NFC-enabled device.

As alluded to previously, the HUD system 2500 is also included in the vehicle 2505. In this example, the HUD system 2500 comprises one or more PGUs 2730, one or more optical elements (e.g., lenses, filters, beam splitters, diffraction gratings, etc.), and one or more combiner elements (or “combiners”). Optical elements that are used to produce holographic images may be referred to as holographic optical elements (HOEs) 2731.

Each of the PGUs 2730 include a projection unit (or “projector”) and a computer device. The projector may be the projection device 2630 discussed previously. The computer device comprises one or more electronic elements that create/generate digital content to be displayed by the projection unit. The computer device may be the processor circuitry 2702, HUD processor 2610, or a similar processing device as discussed previously. The digital content (e.g., text, images, video, etc.) may be any type of content stored by the storage circuitry 2708, streamed from backend system XA30 and/or remote devices via the WC 2709, and/or based on outputs from various sensors 2721, ECUs 2724, and/or actuators 2722. The content to be displayed may include, for example, safety messages (e.g., collision warnings, emergency warnings, pre-crash warnings, traffic warnings, and the like), Short Message Service (SMS)/Multimedia Messaging Service (MMS) messages, navigation system information (e.g., maps, turn-by-turn indicator arrows), movies, television shows, video game images, and the like.

The projection unit (or “projector”) is a device or system that projects still or moving images onto the surface(s) of HOEs 2731 via one or more reflection surfaces (e.g., mirrors) based on signals received from the computer device. The projection unit may include a light generator (or light source) to generate light based on the digital content, which is focused or (re)directed to one or more HOEs (e.g., display surface(s)). The projection unit may include various electronic elements (or an electronic system) that convert the digital content, or signals obtained from the computer device, into signals for controlling the light source to generate/output light of different colors and intensities. In embodiments, the projection unit is or includes the imaging matrix 2650 discussed previously. As examples, a projector of each PGU may be a light emitting diode (LED) projector, a laser diode projector, a liquid crystal display (LCD) projector, a digital light processing (DLP) projector, a digital micro-mirror device (DMD), a microelectromechanical (MEMS) laser scanner, a liquid crystal on silicon (LCoS) matrix/projector, and/or any other like projection device, including those discussed elsewhere herein.

In some implementations, the projection unit may include a collimator (e.g., a one or more lenses, apertures, etc.) to change diverging light from the light source into a parallel beam. In some implementations, the projector may include a combiner (also referred to as “combiner optic” and the like), which may combine different light paths into one light path to define a palette of colors. In some embodiments, the projection unit may comprise scanning mirrors that copy the image pixel-by-pixel and then project the image for display.

In some embodiments, the HUD system 250 or the PGUs 2730 may comprise a relay lens assembly and a combiner element (which may be different than the combiner used for displaying the projected image). The relay lens assembly may comprise one or more relay lenses, which re-image images from the projector into an intermediate image that then reaches an HOE 2731 (e.g., the combiner element) through a reflector.

The generated light may be combined or overlapped with external (e.g., natural) light that is also (re)directed to the same HOE 2731. The HOE 2731 that combines the generated light with the external light may be referred to as a “combiner element” or “combiner.” The combiner may be a beam splitter or semi-transparent display surface located directly in front of the viewer (e.g., operator of vehicle 2505), that redirects the projected image from projector in such a way as to see the field of view and the projected image at the same time. In addition to reflecting the projected light from the projector unit, the combiner element also allows other wavelengths of light to pass through the combiner. In this way, the combiner element (as well as other HOEs 2731) mixes the digital images output by the projector with a viewed real-world to facilitate augmented reality.

The combiner may be formed or made of one or more a pieces of glass, plastic, or other similar material, and may have a coating that enables the combiner to reflect the projected light while allowing external (natural) light to pass through the combiner. In embodiments, the combiner element may be a windshield of the vehicle 2505, a separate semi-reflective surface mounted to a dashboard of the vehicle 2505, a switchable projection screen that switches between high contrast mode (e.g., a frosted or matte) and a transparent (e.g., holographic) mode, or the like. The combiner may have a flat surface or a curved surface (e.g., concave or convex) to aid in focusing the projected image. One or more of the HOEs 2731 may be transmissive optical elements, where the transmitted beam (reference beam) hits the HOE 2731 and the diffracted beam(s) go through the HOE 2731. One or more HOEs 2731 may be reflective optical elements, where the transmitted beam (reference beam) hits the HOE 2731 and the diffracted beam(s) reflects off of the HOE 2731 (e.g., the reference beam and diffracted beams are on the same side of the HOE 2731).

Additionally, one or more of the HOEs 2731 may use waveguide holographic techniques to progressively extract a collimated image guided by total internal reflection (TIR) in a waveguide pipe. The waveguide pipe may be a thin sheet of glass or plastic through which the generated light bounces to route the generated light to the viewer/user. In some embodiments, the HOEs 2731 may utilize holographic diffraction grating (e.g., Bragg diffraction grating) to provide the generated light to the waveguide at a critical angle, which travels through the waveguide. The light is steered toward the user/viewer by one or more other HOEs 2731 that utilize holographic diffraction grating. These HOEs 2731 may comprise grooved reflection gratings and/or a plurality of layers of alternating refraction indexes (e.g., comprising liquid crystals, photoresist substrate, etc.); the grooved reflection gratings and/or the refractive index layers may provide constructive and destructive interference and wavelet dispersion.

The battery 2724 may power the system 2700. In embodiments, the battery 2724 may be a typical lead-acid automotive battery, although in some embodiments, such as when vehicle 2505 is a hybrid vehicle, the battery 2724 may be a lithium ion battery, a metal-air battery, such as a zinc-air battery, an aluminum-air battery, a lithium-air battery, a lithium polymer battery, and the like.

The battery monitor 2726 (e.g., power management integrated circuitry (PMIC) 2726) may be included in the system 2700 to track/monitor various parameters of the battery 2724, such as a state of charge (SoCh) of the battery 2724, state of health (SoH), and the state of function (SoF) of the battery 2724. The battery monitor 2726 may include a battery monitoring IC, which may communicate battery information to the processor circuitry 2702 over the IX 2706.

A power block 2728, or other power supply coupled to an electrical grid, may be coupled with the battery monitor/charger 2726 to charge the battery 2724. In some implementations, the power block 2728 may be replaced with a wireless power receiver to obtain the power wirelessly, for example, through a loop antenna in the system 2700.

While not shown, various other devices may be present within, or connected to, the system 2700. For example, I/O devices, such as a display, a touchscreen, or keypad may be connected to the system 2700 via IX 2706 to accept input and display outputs. In another example, GNSS and/or GPS circuitry and associated applications may be included in or connected with system 2700 to determine a geolocation of the vehicle 2505. In another example, the WC 2709 may include a Universal Integrated Circuit Card (UICC), embedded UICC (eUICC), and/or other elements/components that may be used to communicate over one or more wireless networks.

### 4. Example Implementations

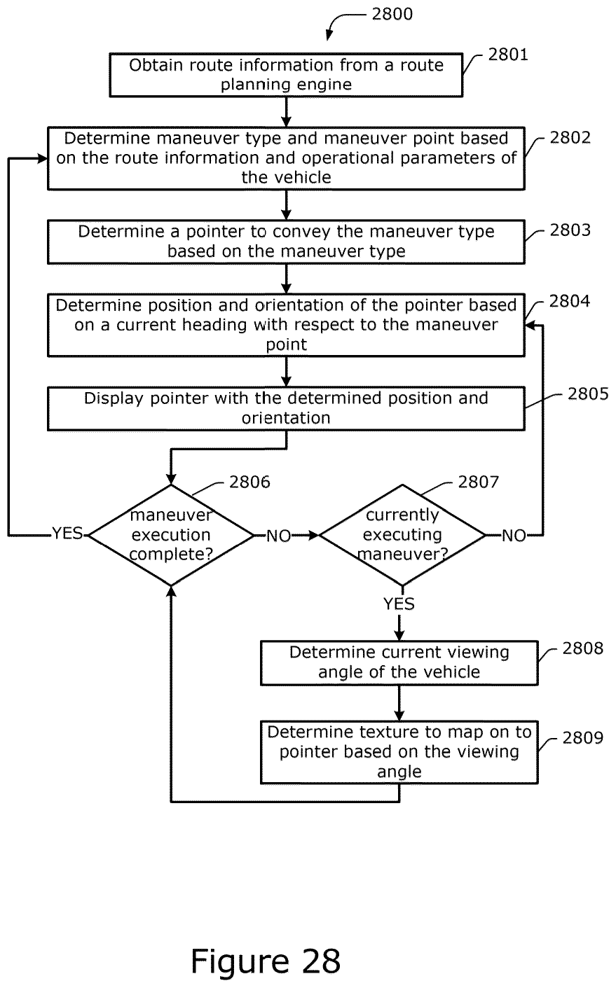

FIG. 28 illustrates a process 2800 for practicing the various embodiments discussed herein. For illustrative purposes, the various operations of process 2800 are described as being performed by a HUD device/system (referred to as a “HUD”) implemented in or by a vehicle, which may correspond to the various HUDs and vehicles discussed herein, or elements thereof. However, it should be noted that process 2800 could be performed by other devices, such as HMDs, AR/VR devices, mobile devices, and the like. While particular examples and orders of operations are illustrated FIG. 28, the depicted orders of operations should not be construed to limit the scope of the embodiments in any way. Rather, the depicted operations may be re-ordered, broken into additional operations, combined, and/or omitted altogether while remaining within the spirit and scope of the present disclosure.

Process 2800 begins at operation 2801 where the HUD obtains route information from a route planning engine. Alternatively, the HUD may obtain TBT information from a navigation app or the like. At operation 2802, the HUD determines a maneuver type and maneuver point based on the route information and operational parameters of the vehicle. As examples, the operational parameters of the vehicle may include one or more of a current travel speed of the vehicle, a current heading of the vehicle, a location of the vehicle with respect to one or more waypoints along the route, and/or any other parameters such as those discussed herein.

At operation 2803, the HUD determines a pointer to be displayed to convey the maneuver type based on the maneuver type. For example, the HUD may determine the pointer to be a gyroscopic pointer when the maneuver type is navigating around a roundabout, and the HUD may determine the pointer to be a directional pointer when the maneuver type is a left or right turn.

At operation 2804, the HUD determines a position and an orientation of the pointer based on a current heading with respect to the maneuver point. Here, the current heading may include a relative position between the vehicle and the maneuver point, an orientation or angle of the vehicle with respect to the maneuver point, and/or a travel direction of the vehicle. The heading may also take into account the travel speed/velocity of the vehicle, and/or other like parameters. At operation 2805, the HUD generates and displays the pointer with the determined position and orientation.

At operation 2806, the HUD determines whether execution of the maneuver has completed. If the maneuver has been completed, the HUD proceeds back to operation 2802 to determine another maneuver type and maneuver point. If the maneuver has not been completed, the HUD proceeds to operation 2807 to determine if the vehicle is currently executing the maneuver. If the vehicle is not currently executing the maneuver, the HUD proceeds back to operation 2804 to update the position and orientation of the pointer based on new/updated heading of the vehicle.

If the vehicle is currently executing the maneuver, the HUD proceeds to operation 2808 to determine a current viewing angle of the vehicle (or pointer). At operation 2809, the HUD determines a texture to map on to the pointer based on the determined viewing angle. For example, the HUD may map a first texture on to the pointer when the viewing angle is within a threshold range of degrees (e.g., when the viewing angle is between about 85° and about 95° or the like), and the HUD may map a second texture onto the pointer the viewing angle is outside of the threshold range of degrees (e.g., when the viewing angle is less than about 85° or greater than about 95° or the like). After performance of operation 2809, the HUD proceeds back to operation 2806 to determine if the maneuver has been completed. Process 2800 may repeat until the journey/route ends and/or until the HUD is powered off.

In a first example, determining the position of the pointer at operation 2804 may include determining a target position along the route at a predefined distance in front of the vehicle; and determining the position and the orientation of the pointer such that a tip of the gyroscopic pointer points at the target position. Additionally or alternatively, operation 2804 may include generating a spline between the vehicle and the maneuver point based on the route information; and generating a smoothed spline based on the generated spline. Additionally or alternatively, operation 2804 may include projecting the target position onto the smoothed route spline at the predefined distance in front of the vehicle. Additionally or alternatively, operation 2804 may include determining the position of the gyroscopic pointer to be a second predefined distance in front of the vehicle, the second predefined distance being less than the first predefined distance. In the first example, displaying the pointer at operation 2805 may include only displaying the pointer at the second predefined distance until execution of the maneuver is completed at operation 2806.

In the first example, determining the orientation of the pointer at operation 2804 may include determining a location of the target position with respect to a current location of the vehicle; yaw rotating (yawing) the pointer about yaw axis extending from a first rotation origin point; roll rotating (rolling) the pointer about a roll axis extending from the first rotation origin point; and pitch rotating (pitching) the pointer about a pitch axis extending from a second rotation origin point different than the first rotation origin point. In the first example, the first rotation origin point is located above the second rotation origin point, and the second rotation origin point is disposed at a center portion of the pointer. The first example may be applicable when the pointer is determined to be the gyroscopic pointer.

In another example, determining the position and orientation of the pointer at operation 2804 may include determining the position of the pointer to be a position of the meaneuver point; and adjusting a size of the pointer in correspondence with a relative distance between a position of the vehicle and the position of the meaneuver point such that the pointer appears less distant from the vehicle as the relative distance becomes smaller (or the pointer appears more distant from the vehicle as the relative distance becomes larger). Additionally or alternatively, determining the position and orientation of the pointer at operation 2804 may include adjusting a shape of the pointer in correspondence with the relative distance between the position of the vehicle and the position of the meaneuver point such that, as the relative distance becomes smaller (or larger), a number of straight line segments of the pointer changes and/or the straight line segments of the pointer becomes rearranged.

In the second example, determining the orientation of the pointer at operation 2804 may include determining the orientation of the pointer to be a direction in which the meaneuver is to be performed. In the second example, displaying the pointer at operation 2805 may include only displaying the pointer at the determined position until execution of the maneuver is completed at operation 2806. In the second example, determining the position of the pointer at operation 2804 and/or displaying the pointer at operation 2805 may include generating a spline between the vehicle and the maneuver point based on the route information; and generating two smoothed splines, each of the two smoothed splines are to be disposed on opposite sides of the generated spline. In the second example, operations 2804 and/or 2805 may further include adjusting each of the two smoothed splines to be disposed outside of a roadway boundary. In the second example, operation 2805 may also include displaying the pointer within an FoV of the HUD and between the two smoothed splines. The second example may be applicable when the pointer is determined to be the directional pointer.

In the first and second example, determining the viewing angle at operation 2808 may include determining an angle of the vehicle with respect to a surface of the pointer. In the first and second examples, determining a texture to map on to the pointer at operation 2809 may include mapping a first texture onto the pointer when the relative distance is larger than a threshold distance and/or when the viewing angle is within a predefined viewing angle range; and mapping a second texture onto the pointer when the relative distance is equal to or less than the threshold distance and/or when the viewing angle is outside a predefined viewing angle range. Here, the second texture may be a more transparent texture than the first texture. Other modifications and/or additions may be made in other examples.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes a method of providing turn-by-turn (TBT) indications for display by a display system during operation of a vehicle, the method comprising: determining a pointer to convey a maneuver to be performed at a maneuver point; and until execution of the maneuver is completed at or around the maneuver point: determining a position and an orientation of the pointer for display in a user interface (UI) of the display system based on a relative position between the vehicle and the maneuver point, and causing the display system to display the pointer in the UI.

Example 2 includes the method of example 1 and/or some other example(s) herein, further comprising: obtaining route information from a local or remote route planning engine, the route information including a plurality of points making up a route; and determining a maneuver type of the maneuver and the maneuver point from the obtained route information.

Example 3 includes the method of example 2 and/or some other example(s) herein, further comprising: determining the position and the orientation of the pointer further based on the maneuver type.

Example 4 includes the method of examples 2-3 and/or some other example(s) herein, determining the maneuver type and the maneuver point further based on current operational parameters of the vehicle, wherein the current operational parameters of the vehicle include one or more of a current travel speed of the vehicle, a current heading of the vehicle, and a location of the vehicle with respect to one or more points of the plurality of points.

Example 5 includes the method of examples 2-4 and/or some other example(s) herein, wherein the plurality of points at least includes an origin point and a destination point.

Example 6 includes the method of examples 2-5 and/or some other example(s) herein, wherein determining the pointer comprises: determining the pointer to be a gyroscopic pointer when the maneuver point is a roundabout or the maneuver to be performed is navigation around the roundabout.

Example 7 includes the method of example 6 and/or some other example(s) herein, wherein determining the position and the orientation of the pointer comprises: determining a target position along the route at a predefined distance in front of the vehicle; and determining the position and the orientation of the pointer such that a tip of the gyroscopic pointer points at the target position.

Example 8 includes the method of example 7 and/or some other example(s) herein, further comprising: generating a spline between the vehicle and the maneuver point based on the route information; and generating a smoothed spline based on the generated spline.

Example 9 includes the method of example 8 and/or some other example(s) herein, further comprising: projecting the target position onto the smoothed route spline at the predefined distance in front of the vehicle.

Example 10 includes the method of examples 8-9 and/or some other example(s) herein, wherein the predefined distance is a first predefined distance, and determining the position of the pointer further comprises: determining the position of the gyroscopic pointer to be a second predefined distance in front of the vehicle, the second predefined distance being less than the first predefined distance.

Example 11 includes the method of example 10 and/or some other example(s) herein, wherein causing the display system to display the pointer in the UI comprises: causing the display system to display the gyroscopic pointer only at the second predefined distance until the execution of the maneuver is completed.

Example 12 includes the method of examples 6-11 and/or some other example(s) herein, wherein determining the orientation of the pointer comprises: determining a location of the target position with respect to a current location of the vehicle; yaw rotating the gyroscopic pointer about yaw axis extending from a first rotation origin point; roll rotating the gyroscopic pointer about a roll axis extending from the first rotation origin point; and pitch rotating the gyroscopic pointer about a pitch axis extending from a second rotation origin point different than the first rotation origin point.

Example 13 includes the method of example 12 and/or some other example(s) herein, wherein the first rotation origin point is located above the second rotation origin point.

Example 14 includes the method of examples 12-13 and/or some other example(s) herein, wherein the second rotation origin point is disposed at a center portion of the gyroscopic pointer.

Example 15 includes the method of examples 2-5 and/or some other example(s) herein, wherein determining the pointer comprises: determining the pointer to be a directional pointer when the maneuver to be performed is a left or right turn.

Example 16 includes the method of example 15 and/or some other example(s) herein, wherein determining the position of the pointer comprises: determining the position of the directional pointer to be a position of the meaneuver point: and adjusting a size of the directional pointer in correspondence with a relative distance between a position of the vehicle and the position of the meaneuver point such that the directional pointer appears less distant from the vehicle as the relative distance becomes smaller.

Example 17 includes the method of example 16 and/or some other example(s) herein, further comprising: mapping a first texture onto the directional pointer when the relative distance is larger than a threshold distance; and mapping a second texture onto the directional pointer when the relative distance is equal to or less than the threshold distance.

Example 18 includes the method of example 18 and/or some other example(s) herein, wherein the second texture is more transparent than the first texture.

Example 19 includes the method of examples 16-18 and/or some other example(s) herein, further comprising: adjusting a shape of the directional pointer in correspondence with the relative distance between the position of the vehicle and the position of the meaneuver point such that, as the relative distance becomes smaller, a number of straight line segments of the directional pointer changes or the straight line segments of the directional pointer are rearranged.

Example 20 includes the method of examples 15-19 and/or some other example(s) herein, wherein determining the orientation of the pointer comprises: determining the orientation of the directional pointer to be a direction in which the meaneuver is to be performed.

Example 21 includes the method of examples 15-20 and/or some other example(s) herein, further comprising: adjusting an amount of transparency of the directional pointer based on an angle of the vehicle with respect to a surface of the directional pointer.

Example 22 includes the method of examples 15-21 and/or some other example(s) herein, further comprising: generating a spline between the vehicle and the maneuver point based on the route information; and generating two smoothed splines, each of the two smoothed splines are to be disposed on opposite sides of the generated spline.

Example 23 includes the method of example 22 and/or some other example(s) herein, wherein causing the display system to display the pointer in the UI comprises: causing the display system to display the directional pointer within a field of view of the display system and between the two smoothed splines.

Example 24 includes the method of examples 22-23 and/or some other example(s) herein, further comprising: adjusting each of the two smoothed splines to be disposed outside of a roadway boundary.

Example 25 includes the method of examples 1-24 and/or some other example(s) herein, determining the position and the orientation of the pointer further based on a relative orientation of the vehicle with respect to the maneuver point and/or the pointer.

Example 26 includes the method of example 25 and/or some other example(s) herein, further comprising: continuously updating the position and/or the orientation of the pointer within the UI until completion of the maneuver based on changes in the relative position and/or changes in the relative orientation.

Example 27 includes the method of examples 1-26 and/or some other example(s) herein, further comprising: continuously causing the display system to display the pointer in the UI comprises continuous displaying the pointer in the UI until after completion of the maneuver.

Example 28 includes the method of examples 1-27 and/or some other example(s) herein, wherein determining the pointer comprises determining the pointer to be the gyroscopic pointer of any one or more of examples 6-14, and the method further comprises: determining the pointer to be the directional pointer of any one or more of examples 15-24 after completion of the maneuver associated with the gyroscopic pointer.

Example 29 includes the method of examples 1-27 and/or some other example(s) herein, wherein determining the pointer comprises determining the pointer to be the directional pointer of any one or more of examples 15-24, and the method further comprises: determining the pointer to be the gyroscopic pointer of any one or more of examples 6-14 after completion of the maneuver associated with the directional pointer.

Example 30 includes the method of examples 1-5 and/or some other example(s) herein, wherein the pointer is a first pointer, and determining the pointer comprises: determining the first pointer to convey the maneuver; and determining a second pointer to convey the maneuver or another maneuver.

Example 31 includes the method of example 30 and/or some other example(s) herein, wherein determining the position and the orientation of the pointer comprises: determining a first position and a first orientation of the first pointer for display in the UI; and determining a second position and a second orientation of the second pointer for display in the UI.

Example 32 includes the method of example 31 and/or some other example(s) herein, wherein causing the display system to display the pointer in the UI comprises: causing the display system to display the first and second pointers in the UI simultaneously; or causing the display system to display the first pointer in the UI before display of the second pointer.

Example 33 includes the method of example 32 and/or some other example(s) herein, wherein the first pointer is the gyroscopic pointer of any one or more of examples 6-14 and the second pointer is the directional pointer of any one or more of examples 15-24.

Example 34 includes the method of example 33 and/or some other example(s) herein, wherein the first pointer is the directional pointer of any one or more of examples 15-24 and the second pointer is the gyroscopic pointer of any one or more of examples 6-14.

Example 35 includes the method of examples 1-34 and/or some other example(s) herein, further comprising: causing the display system to display a speedometer graphical object in the UI, the speedometer graphical object indicating a current speed of the vehicle.

Example 36 includes the method of examples 1-35 and/or some other example(s) herein, further comprising: causing the display system to display a turn-by-turn (TBT) graphical object in the UI, the TBT graphical object indicating the maneuver type.

Example 37 includes a method for operating a display system, the display system comprising a display device, a projection device configured to generate and project light representative of a virtual image, and an imaging matrix disposed between the display device and the projection device, the projection device configured to selectively distribute and propagate the light representative of the virtual image as one or more wave fronts to the display device, and the method comprises: determining a pointer graphical object to convey a maneuver to be performed at a maneuver point ahead of a vehicle along a planned route; and until execution of the maneuver is completed at or around the maneuver point, determining a position and an orientation of the pointer for display by the display device based on a maneuver type of the maneuver and a relative position between the vehicle and the maneuver point, and controlling the projection device to generate the pointer graphical object for display on the display device.

Example 38 includes the method of example 37 and/or some other example(s) herein, wherein determining the pointer comprises: determining the pointer to be a gyroscopic pointer when the maneuver point is a roundabout or the maneuver to be performed is navigation around the roundabout; and determining the pointer to be a directional pointer when the maneuver to be performed is a left or right turn.

Example 39 includes the method of example 38 and/or some other example(s) herein, further comprising: switching between the gyroscopic pointer and the directional pointer as the vehicle approaches different maneuver points.

Example 40 includes the method of examples 38-39 and/or some other example(s) herein, further comprising: when the pointer is the gyroscopic pointer, continuously adjusting the orientation of the gyroscopic pointer such that a tip of the gyroscopic pointer points at a determined target position along the route at a predefined distance in front of the vehicle; and when the pointer is the directional pointer, determining the orientation of the directional pointer such that a tip of the directional pointer points in a direction in which the meaneuver is to be performed.

Example 41 includes the method of examples 37-40 and/or some other example(s) herein, further comprising: obtaining route information from a local or remote route planning engine via an on-board computer communicatively coupled with the HUD processor, the route information including a plurality of points making up the planned route, and the plurality of points at least including an origin point and a destination point; and determining the maneuver type and the maneuver point from the obtained route information.

Example 42 includes the method of examples 41 and/or some other example(s) herein, further comprising: determining the maneuver type and the maneuver point further based on current operational parameters of the vehicle, wherein the current operational parameters of the vehicle include one or more of a current travel speed of the vehicle, a current heading of the vehicle, and a location of the vehicle with respect to one or more points of the plurality of points.

Example 43 includes the method of examples 37-42 and/or some other example(s) herein, wherein the method of any one or more of examples 37-42 is combinable with any one or more of examples 1-36.

Example 44 includes the method of examples 1-43 and/or some other example(s) herein, wherein the display systems is a head-up display (HUD) system, a head-mounted display (HMD) system, a virtual reality (VR) system, or an augmented reality (AR) system.

Example 45 includes one or more computer readable media comprising instructions, wherein execution of the instructions by processor circuitry is to cause the processor circuitry to perform the method of examples 1-44 and/or some other example(s) herein.

Example 46 includes a computer program comprising the instructions of example 45 and/or some other example(s) herein.

Example 47 includes an Application Programming Interface defining functions, methods, variables, data structures, and/or protocols for the computer program of example 39 and/or some other example(s) herein.

Example 48 includes an apparatus comprising circuitry loaded with the instructions of example 45 and/or some other example(s) herein.

Example 49 includes an apparatus comprising circuitry operable to run the instructions of example 45 and/or some other example(s) herein.

Example 50 includes an integrated circuit comprising one or more of the processor circuitry of example 45 and the one or more computer readable media of example 38 and/or some other example(s) herein.

Example 51 includes a computing system comprising the one or more computer readable media and the processor circuitry of example 45 and/or some other example(s) herein.

Example 52 includes an apparatus comprising means for executing the instructions of example 38 and/or some other example(s) herein.

Example 46 includes a signal generated as a result of executing the instructions of example 38 and/or some other example(s) herein.

Example 53 includes a data unit generated as a result of executing the instructions of example 45 and/or some other example(s) herein.

Example 54 includes the data unit of example 53 and/or some other example(s) herein, the data unit is a datagram, network packet, data frame, data segment, a Protocol Data Unit (PDU), a Service Data Unit (SDU), a message, or a database object.

Example 55 includes a signal encoded with the data unit of examples 53-54 and/or some other example(s) herein.

Example 56 includes an electromagnetic signal carrying the instructions of example 38 and/or some other example(s) herein.

Example 57 includes an optical system, comprising: a projection unit arranged to generate light representative of at least one virtual image; an imaging matrix arranged to propagate the light as one or more wave fronts onto a display surface; and processor circuitry operable to control the projection unit and run the instructions of example 45 and/or some other example(s) herein.

Example 58 includes an apparatus comprising means for performing the method of examples 1-44 and/or some other example(s) herein.

### 5. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B. and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including.” “having.” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “coupling”, “coupling means”, or the like refers to device that mechanically and/or chemically joins or couples two or more objects together, and may include threaded fasteners (e.g., bolts, screws, nuts, threaded rods, etc.), pins, linchpins, r-clips, clips, pegs, clamps, dowels, cam locks, latches, catches, ties, hooks, magnets, rivets, assembled joineries, molded joineries, metallurgical formed joints/bonds (e.g., by welding, brazing, soldering, etc.), adhesive bonds, and/or the like. Additionally or alternatively, the term “coupling”, “coupling means”, or the like refers to the act of mechanically and/or chemically joining or coupling two or more objects together, and may include any type of fastening, welding, brazing, soldering, sintering, casting, plating, adhesive bonding, and/or the like.

The term “fabrication” refers to the formation, construction, or creation of a structure using any combination of materials and/or using fabrication means. The term “fabrication means” as used herein refers to any suitable tool or machine that is used during a fabrication process and may involve tools or machines for cutting (e.g., using manual or powered saws, shears, chisels, routers, torches including handheld torches such as oxy-fuel torches or plasma torches, and/or computer numerical control (CNC) cutters including lasers, mill bits, torches, water jets, routers, laser etching tools/machines, tolls/machines for printed circuit board (PCB) and/or semiconductor manufacturing, etc.), bending (e.g., manual, powered, or CNC hammers, pan brakes, press brakes, tube benders, roll benders, specialized machine presses, etc.), forging (e.g., forging press, machines/tools for roll forging, swaging, cogging, open-die forging, impression-die forging (close die forging), press forging, cold forging automatic hot forging and upsetting, etc.), assembling (e.g., by welding, soldering, brazing, crimping, coupling with adhesives, riveting, fasteners, etc.), molding or casting (e.g., die casting, centrifugal casting, injection molding, extrusion molding, matrix molding, etc.), additive manufacturing (e.g., direct metal laser sintering, filament winding, fused deposition modeling, laminated object manufacturing techniques, induction printing, selecting laser sintering, spark plasma sintering, stereolithographic, three-dimensional (3D) printing techniques including fused deposition modeling, selective laser melting, selective laser sintering, composite filament fabrication, fused filament fabrication, stereo lithography, directed energy deposition, electron beam freeform fabrication, etc.), PCB and/or semiconductor manufacturing techniques (e.g., silk-screen printing, photolithography, photoengraving, PCB milling, laser resist ablation, laser etching, plasma exposure, atomic layer deposition (ALD), molecular layer deposition (MLD), chemical vapor deposition (CVD), rapid thermal processing (RTP), and/or the like).

The terms “flexible,” “flexibility,” and/or “pliability” refer to the ability of an object or material to bend or deform in response to an applied force; “the term “flexible” is complementary to “stiffness.” The term “stiffness” and/or “rigidity” refers to the ability of an object to resist deformation in response to an applied force. The term “elasticity” refers to the ability of an object or material to resist a distorting influence or stress and to return to its original size and shape when the stress is removed. Elastic modulus (a measure of elasticity) is a property of a material, whereas flexibility or stiffness is a property of a structure or component of a structure and is dependent upon various physical dimensions that describe that structure or component.

The term “wear” refers to the phenomenon of the gradual removal, damaging, and/or displacement of material at solid surfaces due to mechanical processes (e.g., erosion) and/or chemical processes (e.g., corrosion). Wear causes functional surfaces to degrade, eventually leading to material failure or loss of functionality. The term “wear” as used herein may also include other processes such as fatigue (e.g., he weakening of a material caused by cyclic loading that results in progressive and localized structural damage and the growth of cracks) and creep (e.g., the tendency of a solid material to move slowly or deform permanently under the influence of persistent mechanical stresses). Mechanical wear may occur as a result of relative motion occurring between two contact surfaces. Wear that occurs in machinery components has the potential to cause degradation of the functional surface and ultimately loss of functionality. Various factors, such as the type of loading, type of motion, temperature, lubrication, and the like may affect the rate of wear.

The term “lateral” refers to directions or positions relative to an object spanning the width of a body of the object, relating to the sides of the object, and/or moving in a sideways direction with respect to the object.

The term “longitudinal” refers to directions or positions relative to an object spanning the length of a body of the object; relating to the top or bottom of the object, and/or moving in an upwards and/or downwards direction with respect to the object.

The term “linear” refers to directions or positions relative to an object following a straight line with respect to the object, and/or refers to a movement or force that occurs in a straight line rather than in a curve.

The term “lineal” refers to directions or positions relative to an object following along a given path with respect to the object, wherein the shape of the path is straight or not straight.

The term “vertex” refers to a corner point of a polygon, polyhedron, or other higher-dimensional polytope, formed by the intersection of edges, faces or facets of the object. A vertex is “convex” if the internal angle of the polygon (i.e., the angle formed by the two edges at the vertex with the polygon inside the angle) is less than π radians (180°); otherwise, it is a “concave” or “reflex” polygon.

The term “spline” refers to a function that is defined by polynomials in a piecewise manner, or to a piecewise polynomial (parametric) curve. The term “spline” may refer to a wide class of functions that are used in applications requiring data interpolation and/or smoothing.

The term “compass” refers to any instrument, device, or element used for navigation and orientation that shows a direction relative to a direction, such as a geographic cardinal directions (or points).

The term “texture” in the context of computer graphics and/or UX/UI design, may refer to the small-scale geometry on the surface of a graphical object. Additionally or alternatively, the term “texture” in this context may refer to the repetition of an element or pattern, called surface texel, that is then mapped on to the surface of a graphical object. Furthermore, a “texture” may be In a deterministic (regular) texture or a statistical (irregular) texture. Deterministic textures are created by repetition of a fixed geometric shape, where texels are represented by the parameters of the geometric shape. Statistical textures are created by changing patterns with fixed statistical properties, and may be represented by spatial frequency properties.

The term “maneuver” (sometimes spelled “manoeuvre” or “maneuver”) refers to one or more movements bringing an actor (e.g., a vehicle, a pedestrian, etc.) from one position to another position. Additionally or alternatively, the term “maneuver” may refer to one or more operations or movements to be performed during turn-by-turn navigation, such as a turn, and may also include an expected duration of the operations and/or movements.

The term “turn-by-turn navigation” refers to directions provided to a human vehicle operator via text, speech, or graphics, for the purposes of traveling to a desired destination.

The term “circuitry” refers to a circuit or system of multiple circuits configurable to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), System-on-Chip (SoC), System-in-Package (SiP), Multi-Chip Package (MCP), digital signal processor (DSP), etc., that are configurable to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

As used herein, the term “element” may refer to a unit that is indivisible at a given level of abstraction and has a clearly defined boundary, wherein an element may be any type of entity. The term “entity” may refer to (1) a distinct component of an architecture or device, or (2) information transferred as a payload. As used herein, the term “device” may refer to a physical entity embedded inside, or attached to, another physical entity in its vicinity, with capabilities to convey digital information from or to that physical entity. The term “controller” may refer to an element or entity that has the capability to affect a physical entity, such as by changing its state or causing the physical entity to move.

The term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configurable to share computing and/or networking resources. Examples of “computer devices.” “computer systems,” etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “content” refers to visual or audible information to be conveyed to a particular audience or end-user, and may include or convey information pertaining to specific subjects or topics. Content or content items may be different content types (e.g., text, image, audio, video, etc.), and/or may have different formats (e.g., text files including Microsoft® Word® documents, Portable Document Format (PDF) documents, HTML documents; interactive map and/or route planning data, audio files such as MPEG-4 audio files and WebM audio and/or video files; etc.). As used herein, the term “service” refers to a particular functionality or a set of functions to be performed on behalf of a requesting party, such as the system 900. As examples, a service may include or involve the retrieval of specified information or the execution of a set of operations. Although the terms “content” and “service” refer to different concepts, the terms “content” and “service” may be used interchangeably throughout the present disclosure, unless the context suggests otherwise.

The foregoing description of one or more implementations provides illustration and description of various example embodiment, but is not intended to be exhaustive or to limit the scope of embodiments to the precise form disclosed. Modifications and variations are possible in light of the above teachings or may be acquired from practice of various embodiments, Where specific details are set forth in order to describe example embodiments of the disclosure, it should be apparent to one skilled in the art that the disclosure can be practiced without, or with variation of, these specific details. The description is thus to be regarded as illustrative instead of limiting.

1-40. (canceled)

41. A non-transitory computer readable medium (NCTRM) comprising instructions for providing turn-by-turn (TBT) navigation indications to be displayed by a display system during operation of a vehicle, wherein execution of the instructions by one or more processors of a computing device is to cause the computing device to:
determine a turn indicator to convey a maneuver to be performed at a maneuver point; and
until execution of the maneuver is completed at or around the maneuver point:
determine a position and an orientation of the turn indicator for display in a user interface (UI) of the display system based on a relative position between the vehicle and the maneuver point, and
cause the display system to display the turn indicator in the UI.

42. The NTCRM of claim 41, wherein execution of the instructions is to cause the computing device to:
obtain route information from a local or remote route planning engine, wherein the route information including a plurality of points making up a route;
determine a maneuver type of the maneuver and the maneuver point from the obtained route information; and
determine the position and the orientation of the turn indicator based on the maneuver type.

43. The NTCRM of claim 42, wherein execution of the instructions is to cause the computing device to:
determine the maneuver type and the maneuver point based on current operational parameters of the vehicle, wherein the current operational parameters of the vehicle include one or more of a current travel speed of the vehicle, a current heading of the vehicle, and a location of the vehicle with respect to one or more points of the plurality of points.

44. The NTCRM of claim 42, wherein, to determine the turn indicator, execution of the instructions is to cause the computing device to:
determine the turn indicator to be a gyroscopic turn indicator when the maneuver point is a roundabout or when the maneuver to be performed is navigation around the roundabout.

45. The NTCRM of claim 44, wherein, to determine the position and the orientation of the turn indicator, execution of the instructions is to cause the computing device to:
determine a target position along the route at a predefined distance in front of the vehicle; and
determine the position and the orientation of the turn indicator such that a tip of the gyroscopic turn indicator points at the target position.

46. The NTCRM of claim 45, wherein execution of the instructions is to cause the computing device to:
generate a spline between the vehicle and the maneuver point based on the route information;
generate a smoothed spline based on the generated spline; and
project the target position onto the smoothed spline at the predefined distance in front of the vehicle.

47. The NTCRM of claim 46, wherein the predefined distance is a first predefined distance, and to determine the position of the turn indicator, execution of the instructions is to cause the computing device to:
determine the position of the gyroscopic turn indicator to be a second predefined distance in front of the vehicle, wherein the second predefined distance is less than the first predefined distance.

48. The NTCRM of claim 47, wherein, to cause the display system to display the turn indicator in the UI, execution of the instructions is to cause the computing device to:
cause the display system to display the gyroscopic turn indicator only at the second predefined distance until the execution of the maneuver is completed.

49. The NTCRM of claim 45, wherein, to determine the orientation of the turn indicator, execution of the instructions is to cause the computing device to:
determine a location of the target position with respect to a current location of the vehicle;
yaw rotate the gyroscopic turn indicator about yaw axis extending from a first rotation origin point;
roll rotate the gyroscopic turn indicator about a roll axis extending from the first rotation origin point; and
pitch rotate the gyroscopic turn indicator about a pitch axis extending from a second rotation origin point different than the first rotation origin point.

50. The NTCRM of claim 49, wherein the first rotation origin point is located above the second rotation origin point, and the second rotation origin point is disposed at a center portion of the gyroscopic turn indicator.

51. The NTCRM of claim 42, wherein, to determine the turn indicator, execution of the instructions is to cause the computing device to:
determine the turn indicator to be a directional turn indicator when the maneuver to be performed is a left or right turn.

52. The NTCRM of claim 51, wherein, to determine the position of the turn indicator, execution of the instructions is to cause the computing device to:
determine the position of the directional turn indicator to be a position of the maneuver point; and
adjusting a size of the directional turn indicator in correspondence with a relative distance between a position of the vehicle and the position of the maneuver point such that the directional turn indicator appears less distant from the vehicle as the relative distance becomes smaller.

53. The NTCRM of claim 52, wherein execution of the instructions is to cause the computing device to:
map a first texture onto the directional turn indicator when the relative distance is larger than a threshold distance; and
map a second texture onto the directional turn indicator when the relative distance is equal to or less than the threshold distance, wherein the second texture is more transparent than the first texture.

54. The NTCRM of claim 52, wherein execution of the instructions is to cause the computing device to:
adjust a shape of the directional turn indicator in correspondence with the relative distance between the position of the vehicle and the position of the maneuver point such that, as the relative distance becomes smaller, a number of straight line segments of the directional turn indicator changes or the straight line segments of the directional turn indicator are rearranged.

55. The NTCRM of claim 51, wherein, to determine the orientation of the turn indicator, execution of the instructions is to cause the computing device to:
determine the orientation of the directional turn indicator to be a direction in which the maneuver is to be performed.

56. The NTCRM of claim 51, wherein execution of the instructions is to cause the computing device to:
adjust an amount of transparency of the directional turn indicator based on an angle of the vehicle with respect to a surface of the directional turn indicator.

57. The NTCRM of claim 51, wherein execution of the instructions is to cause the computing device to:
generate a spline between the vehicle and the maneuver point based on the route information; and
generate two smoothed splines, each of the two smoothed splines are to be disposed on opposite sides of the generated spline.

58. The NTCRM of claim 57, wherein, to cause the display system to display the turn indicator in the UI, execution of the instructions is to cause the computing device to:
cause the display system to display the directional turn indicator within a field of view of the display system and between the two smoothed splines.

59. The NTCRM of claim 57, wherein execution of the instructions is to cause the computing device to:
adjust each of the two smoothed splines to be disposed outside of a roadway boundary.

60. The NTCRM of claim 41, wherein the display system is a head-up display (HUD) system, a head-mounted display (HMD) system, a helmet mounted display system, a virtual reality (VR) display system, or an augmented reality (AR) display system.
